(19) United States
(12) Patent Application Publication
(10) Pub. No.: US 2025/0202119 A1
(43) Pub. Date: Jun. 19, 2025

(54) DIELECTRIC RESONATOR ANTENNA SUBARRAY

(71) Applicant: ROGERS CORPORATION, Chandler, AZ (US)

(72) Inventors: Kristi PANCE, Auburndale, MA (US); SHAILESH PANDEY, Woburn, MA (US); Robert Allen KIMBALL, Gilbert, AZ (US); Dirk BAARS, Phoenix, AZ (US)

(21) Appl. No.: 18/981,062

(22) Filed: Dec. 13, 2024

Related U.S. Application Data
(60) Provisional application No. 63/556,209, filed on Feb. 21, 2024.
(60) Provisional application No. 63/610,683, filed on Dec. 15, 2023.

(51) Int. Cl. H01Q 9/04; H01Q 21/00

(52) U.S. Cl. CPC H01Q 9/0485; H01Q 21/0093

(57) ABSTRACT

An electromagnetic, EM, device (1000) configured to be operational at a defined center frequency, f, having a free space wavelength, λ, is disclosed. The EM device (1000) includes: a plurality of dielectric resonator antennas, DRAs, that can resonate at the same frequency, f, (3100) forming a unit cell (3200) having an overall footprint of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100), the unit cell (3200) defining a DRA subarray (3000).

### CROSS REFERENCE TO RELATED APPLICATIONS

This application claims the benefit of U.S. Provisional Application No. 63/556,209, filed on Feb. 21, 2024, and claims the benefit of U.S. Provisional Application No. 63/610,6, filed on Dec. 15, 2023, both of which are incorporated by reference in their entirety herein.

### BACKGROUND

The present disclosure relates generally to an electromagnetic, EM, device, and particularly to a dielectric resonator antenna, DRA, subarray.

While existing EM devices having a DRA may be suitable for their intended purpose, the art relating to such devices would be advanced by a construct as disclosed herein.

### BRIEF SUMMARY

An embodiment includes an EM device as defined by the appended independent claim(s). Further advantageous modifications of the EM device are defined by the appended dependent claims.

An embodiment includes an electromagnetic, EM, device (1000) configured to be operational at a defined center frequency, f, having a free space wavelength, λ. The EM device (1000) includes: a plurality of dielectric resonator antennas, DRAs, that can resonate at the same frequency, f, (3100) forming a unit cell (3200) having an overall footprint of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100), the unit cell (3200) defining a DRA subarray (3000).

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1A depicts a rotated isometric view of an EM device having a 13×13 DRA subarray, in accordance with an embodiment;

FIG. 1B depicts a rotated isometric view of a single DRA of the DRA subarray of FIG. 1A, in accordance with an embodiment;

FIG. 1C depicts a rotated isometric view of another single DRA similar to that of FIG. 1B, but illustrated with a different height to base dimension aspect ratio, in accordance with an embodiment;

FIG. 1D depicts a rotated isometric view of the single DRA of FIG. 1B with geometric relationships illustrated, in accordance with an embodiment;

FIGS. 2A, 2B, and 2C, depict various views, top-down rotated isometric, side view, bottom-up rotated isometric, respectively, of a 2×2 DRA silicon subarray sized within an overall footprint of λ/2×λ/2 and suitable for 140 GHz applications, in accordance with an embodiment;

FIGS. 3A, 3B, 3C, and 3D, depict various views, top-down rotated isometric, bottom-up rotated isometric, side view, expanded partial view, respectively, of a 3×3 DRA silicon subarray sized within an overall footprint of λ/2×λ/2 and suitable for 140 GHz applications, in accordance with an embodiment;

FIGS. 4A and 4B respectively depict, a transparent rotated isometric view of the DRA subarray FIG. 1A, and an associated single DRA, with analytical modeling results that illustrate E-field energy propagation within non-DRA space, in accordance with an embodiment;

FIG. 5 depicts a rotated isometric view of the 3×3 DRA subarray of FIG. 3A, but with an encapsulant, in accordance with an embodiment;

FIGS. 6A and 6B respectively depict, a rotated isometric view of a single DRA of FIG. 1A, and an expanded view of a portion thereof, with a single signal line, in accordance with an embodiment;

FIGS. 6C and 6D respectively depict, a rotated isometric view of a single DRA of FIG. 1A, and an expanded view of a portion thereof, with a dual signal line, in accordance with an embodiment;

FIG. 7 depicts an alternate subarray to that depicted in FIG. 1A, illustrating individual DRAs having a triangular pyramid 3D shape, in accordance with an embodiment;

FIG. 8A depicts a top down plan view of the 13×13 DRA subarray of FIG. 1A with an artistic representation of a single DRA being a pixel-like feature of the DRA subarray, in accordance with an embodiment;

FIG. 8B depicts a top down plan view of four 13×13 DRA subarrays of FIG. 8A arranged in an x by y array, in accordance with an embodiment;

FIGS. 9A, 9B, and 9C, respectively depict, an example patch antenna, associated analytical return loss data for the same, and associated analytical radiation pattern data for the same, for comparative purposes, in accordance with an embodiment;

FIG. 10A depicts the example patch antenna of FIG. 9A; and, FIG. 10B depicts the 13×13 DRA subarray of FIGS. 1A, 4A, and 8A, where both devices are suitable for operation at 1 GHz with a λ/2 footprint for comparison purposes, in accordance with an embodiment;

FIGS. 11A, 11B, and 11C, respectively depict, associated analytical E-field distribution data for the 13×13 DRA subarray of FIGS. 1A, 4A, 8A, and 10B, associated analytical radiation pattern data for the same, and associated analytical return loss data for the same, in accordance with an embodiment;

FIG. 12 depicts various views of the single DRA of FIG. 1B with associated analytical E-field distribution data for a given radiation periodic boundary condition to illustrate E-field energy and density being substantially higher outside of the DRA (in non-DRA space) as compare to within the DRA, in accordance with an embodiment;

FIG. 13 depicts two views of analytical E-field distribution data for the DRA subarray of FIGS. 1A, 4A, and 8A, for two different radiation periodic boundary conditions to illustrate controlled beam steering capabilities of the direction of EM radiation, in accordance with an embodiment;

FIGS. 14A, 14B, and 14C, depict various radiation periodic boundary conditions for analytical simulations, in accordance with an embodiment;

FIGS. 15A, 15B, 15C, and 15D, depict analytical modeling results for various radiation periodic boundary conditions relating to the conditions depicted in FIGS. 14A, 14B, and 14C, in accordance with an embodiment;

FIGS. 16A and 16B depict similar structure to that disclosed in FIGS. 1A-15D, and analytical simulation results, suitable for wireless charging at low frequencies, in accordance with an embodiment.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

An embodiment, as shown and described by the various figures and accompanying text, provides an EM device in the form of a monolithic DRA subarray. While certain embodiments described and/or illustrated herein depict a certain size DRA subarray (i.e., 2×2 or 13×13 for example), it will be appreciated that the disclosed invention is not so limited and also encompasses other sized arrays of the DRA subarray, such as 20×20 or higher depending on loading for example.

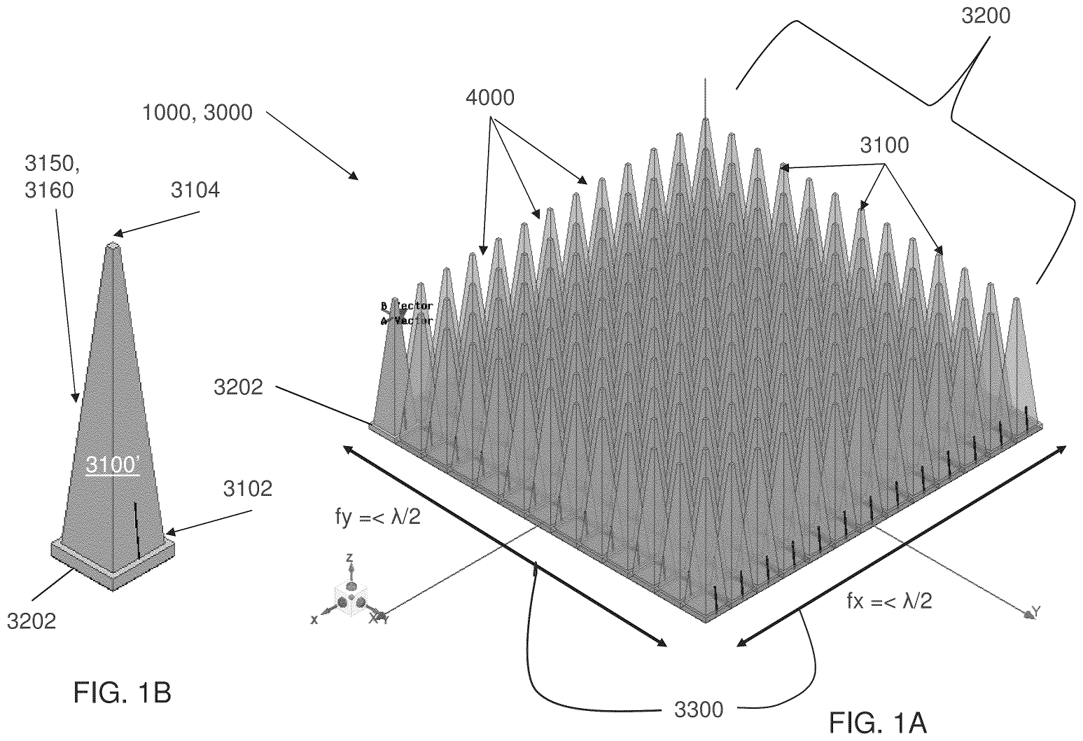

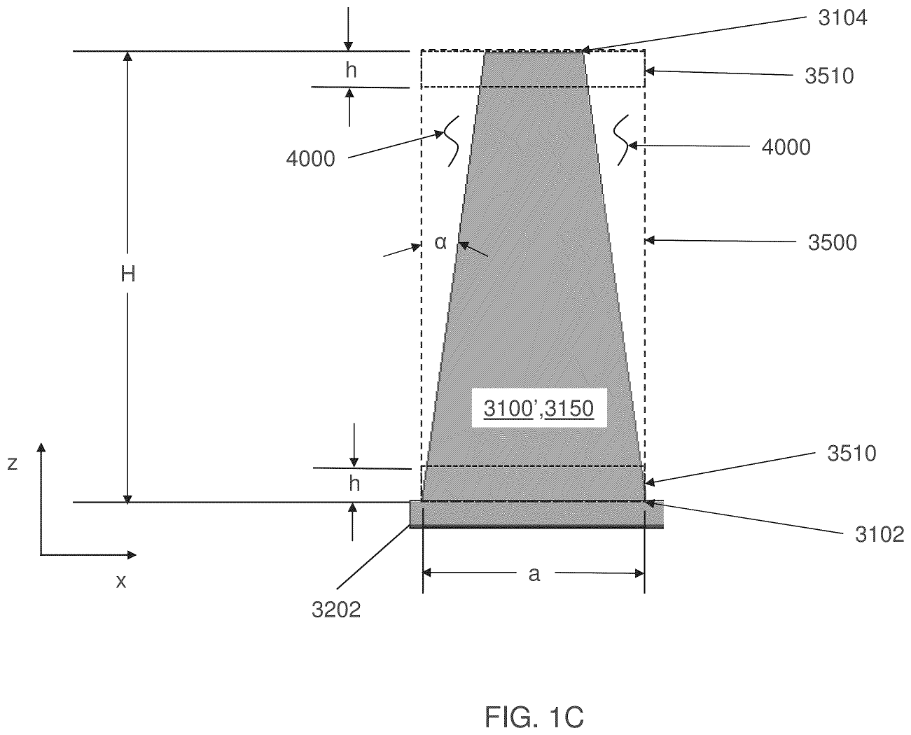

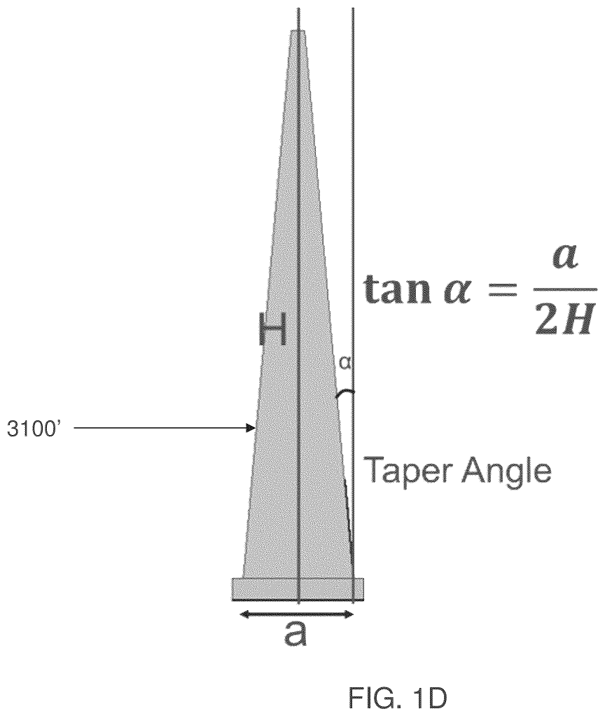

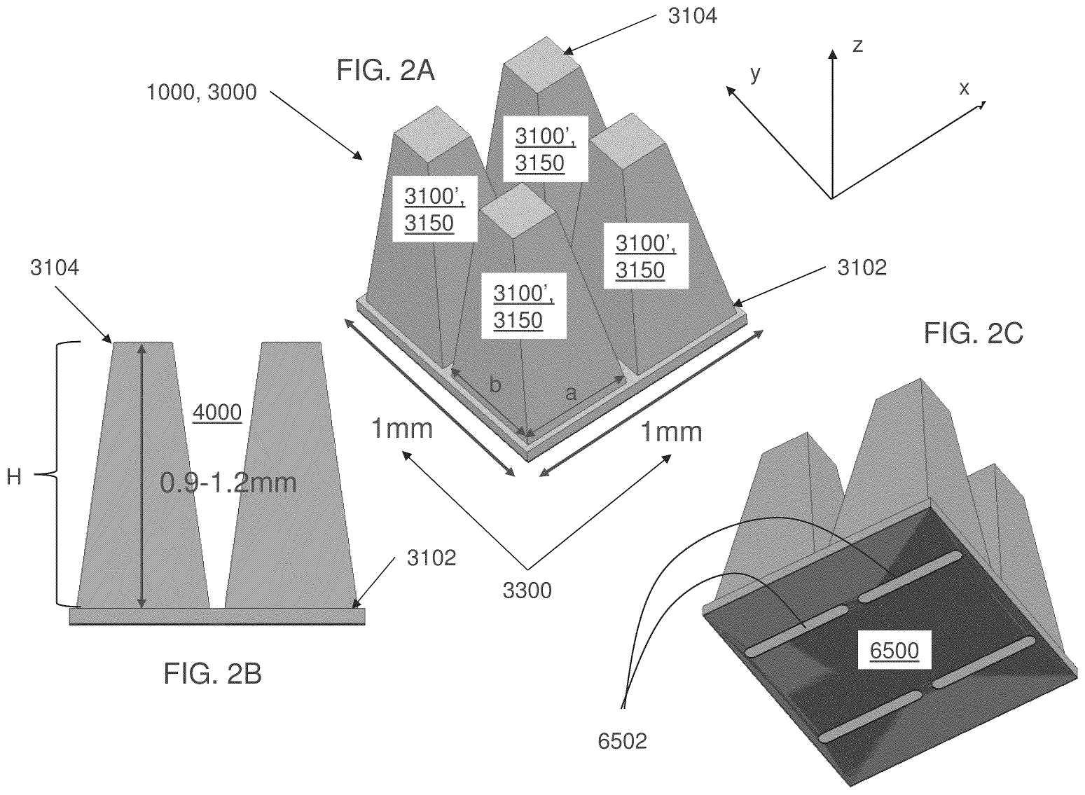

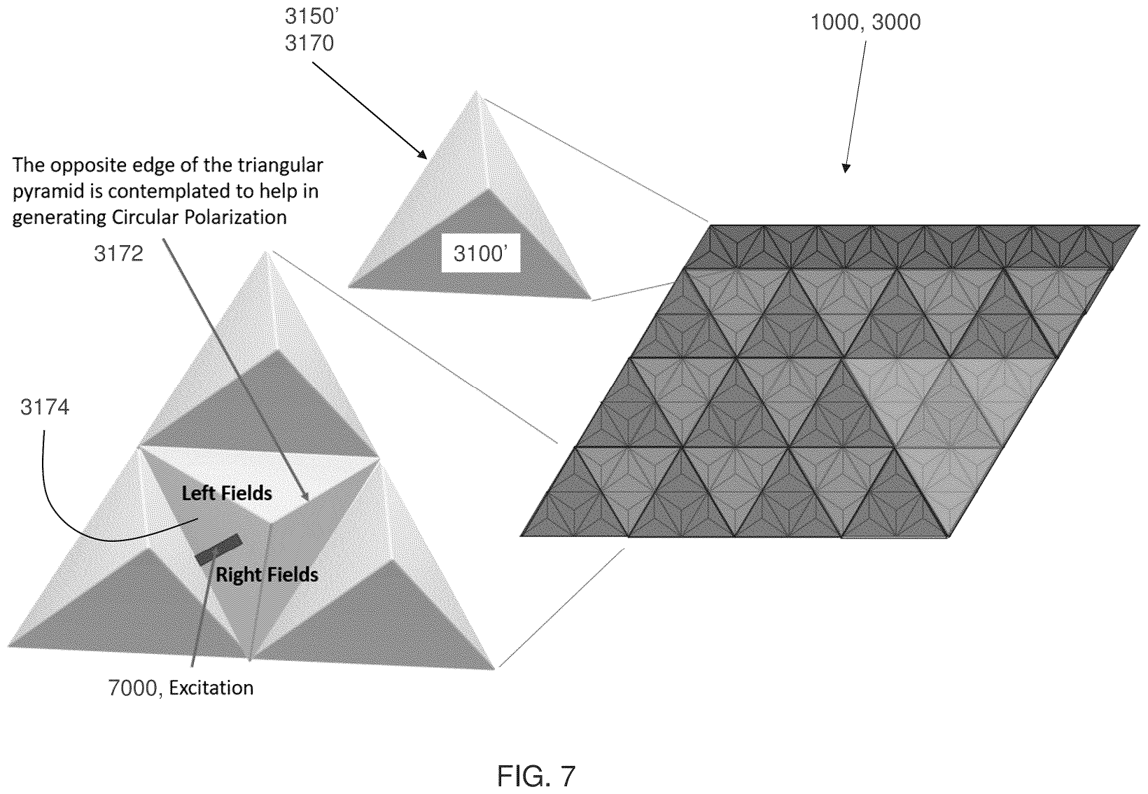

With reference to FIGS. 1A-1D collectively, an embodiment includes an electromagnetic, EM, device (1000) configured to be operational at a defined center frequency, f, having a free space wavelength, λ, the EM device (1000) comprising: a plurality of dielectric resonator antennas, DRAs, (3100) that can resonate at the same frequency, f, forming a unit cell (3200) having an overall footprint fx×fy (also referred to herein by reference numeral 3300) of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100), the unit cell (3200) defining a DRA subarray (3000). In an example embodiment, a dielectric constant, Dk, value of the unit cell (3200) is 190. In an embodiment, the unit cell (3200) is a monolithic construct. In an embodiment, each DRA (3100′) of the plurality of DRAs (3100) is a solid, non-hollow, construct. In an embodiment, the unit cell (3200) is a dielectric-only construct. In an embodiment, the unit cell (3200) comprises a magneto-dielectric material (MDM). The employment of MDM is well suited for use in a 13×13 unit cell (3200) at low frequencies such as 1 GHz or less, as disclosed herein. In an embodiment, each DRA (3100′) of the plurality of DRAs (3100) has a same 3D shape and size (3150). In an embodiment, the 3D shape (3150) of each DRA (3100′) has a proximal end (3102) proximate a base (3202) of the unit cell (3200), the base (3202) being monolithic with each DRA (3100′), and an opposing distal end (3104) at a distance from the base (3202), the 3D shape (3150) tapering inward from the proximal end (3102) to the distal end (3104) to form and define non-DRA space (4000) between each adjacent DRA (3100′) of the plurality of DRAs (3100). In an embodiment, the DRA subarray (3000) comprises a dielectric material having a first Dk value, and the non-DRA space (4000) comprises a dielectric material having a second Dk value that is less than the first Dk value. In an embodiment, the first Dk value is equal to or greater than 50 and equal to or less than 2,000, alternatively equal to or greater than 100 and equal to or less than 1,000, and the second Dk value is equal to or greater than 1 and equal to or less than 5. In an embodiment, the inwardly tapered 3D shape (3150) has a first effective Dk value at the proximal end (3102), and a second effective Dk value at the distal end (3104) that is less than the first effective Dk value, wherein the respective effective Dk value is defined by the Dk value associated with incremental and uniform 3D cross sectional slices (3510) in the z-direction of a non-tapered envelope (3500) that bounds both the 3D shape (3150) of the respective DRA (3100′) and the associated portion of non-DRA space (4000) about the respective DRA (3100′), and wherein a thickness h of the 3D cross sectional slices (3510) in the z-direction is equal to or less than 10% of an overall height H of the respective DRA (3100′) in the z-direction. While only a lower slice (3510) and an upper slice (3510) is depicted in FIG. 2D, it will be appreciated that this is only for clarity of illustration, and that for analysis purposes the number of slices would be consecutive and adjacent each other from the lower to the upper slice (3510). In an embodiment, the first effective Dk value is equal to or greater than 8 and equal to or less than 16, alternatively equal to or greater than 16 and equal to or less than 100, further alternatively equal to or greater than 100 and equal to or less than 1000, and the second effective Dk value is equal to or greater than 1 and equal to or less than 5, alternatively equal to or greater than 2.5 and equal to or less than 4. In an embodiment, the inwardly tapered 3D shape (3150) has a taper angle α of equal to or greater than 5-degrees and equal to or less than 35-degrees, alternatively equal to or greater than 25-degrees and equal to or less than 30-degrees, further alternatively equal to or greater than 5-degrees and equal to or less than 20-degrees. In an embodiment, each DRA (3100′) of the plurality of DRAs (3100) has a 3D rectangular pyramid shape (3160) (see FIG. 1B for example), or a 3D triangular pyramid shape (3170) (see FIG. 7 for example), which may or may not be truncated at the distal end (3104). In an embodiment, the center frequency f is equal to or greater than 50 KHz and equal to or less than 50 MHZ, alternatively f is equal to or greater than 1 GHZ, and equal to or less than 1000 GHz.

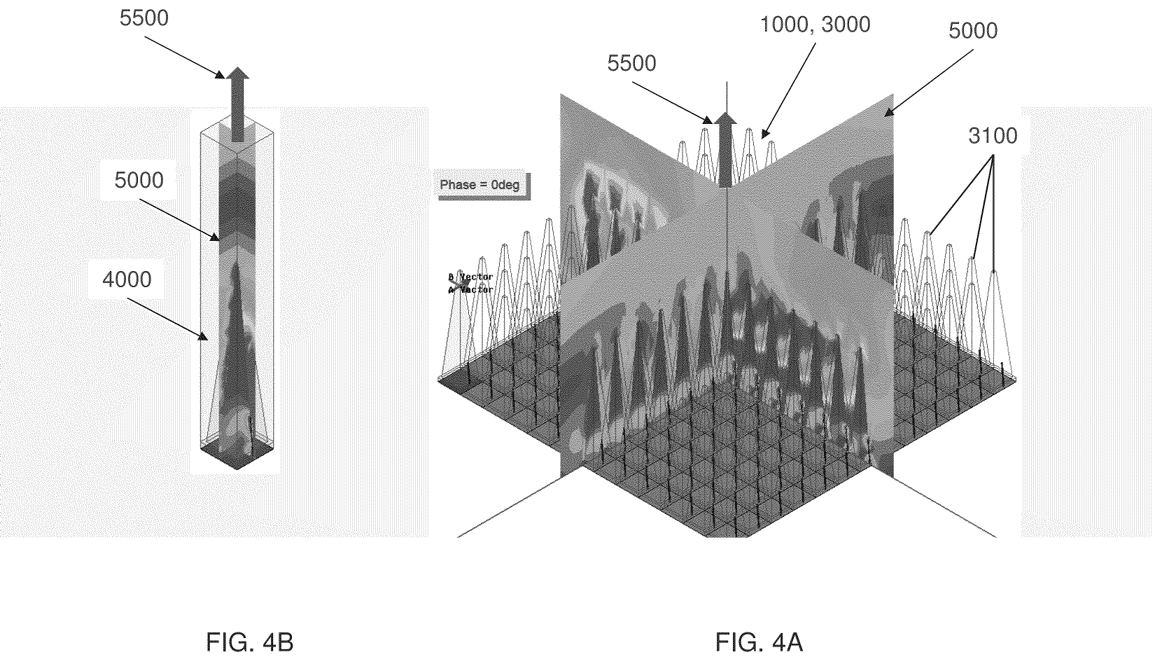

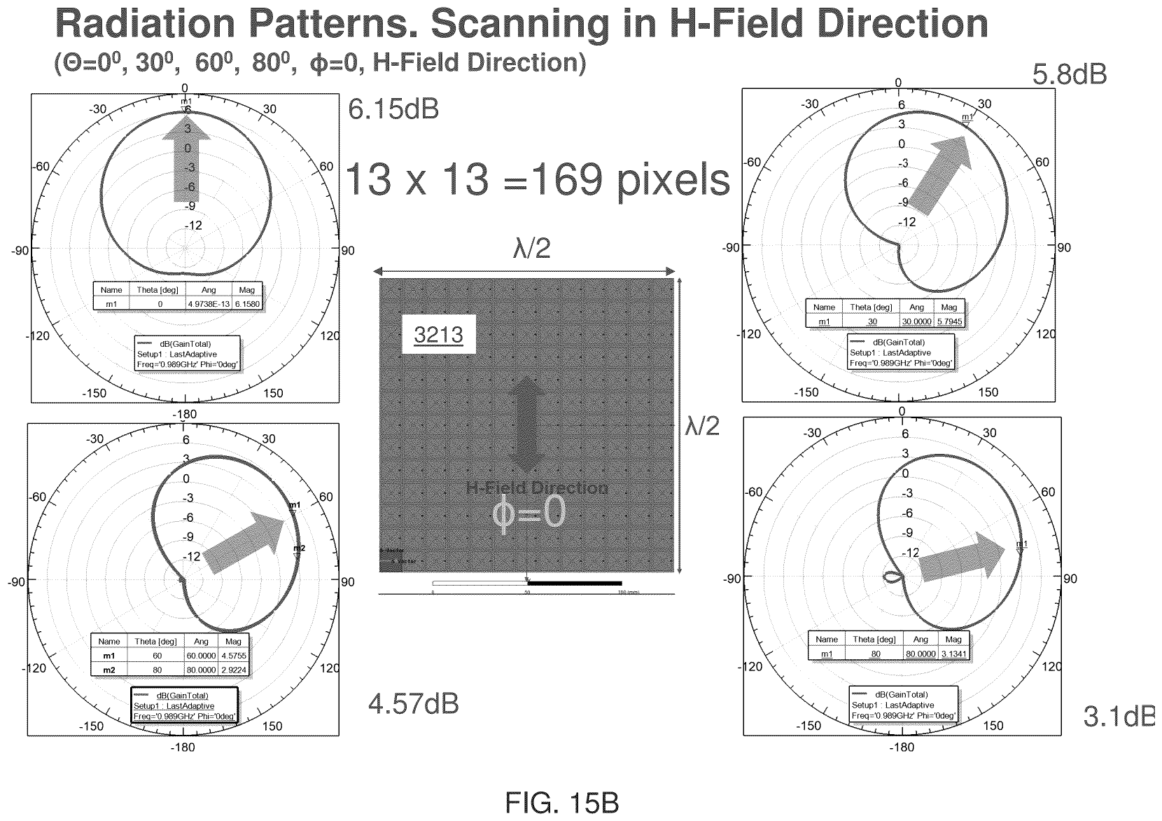

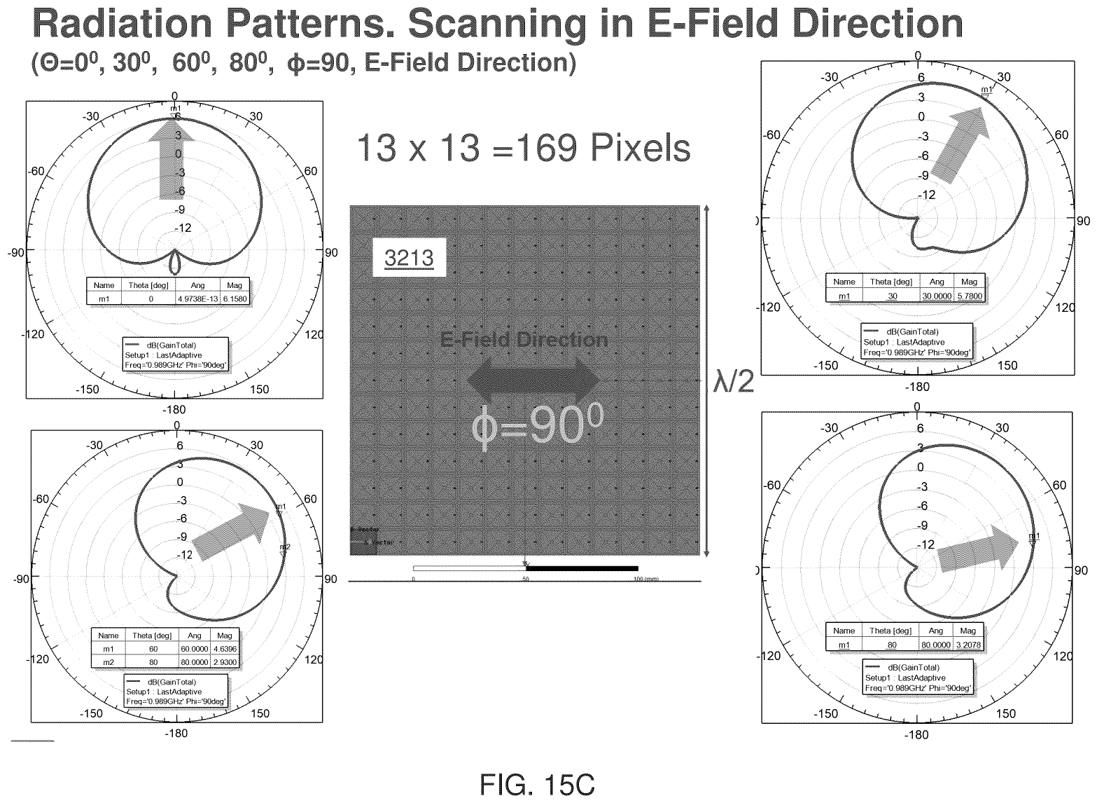

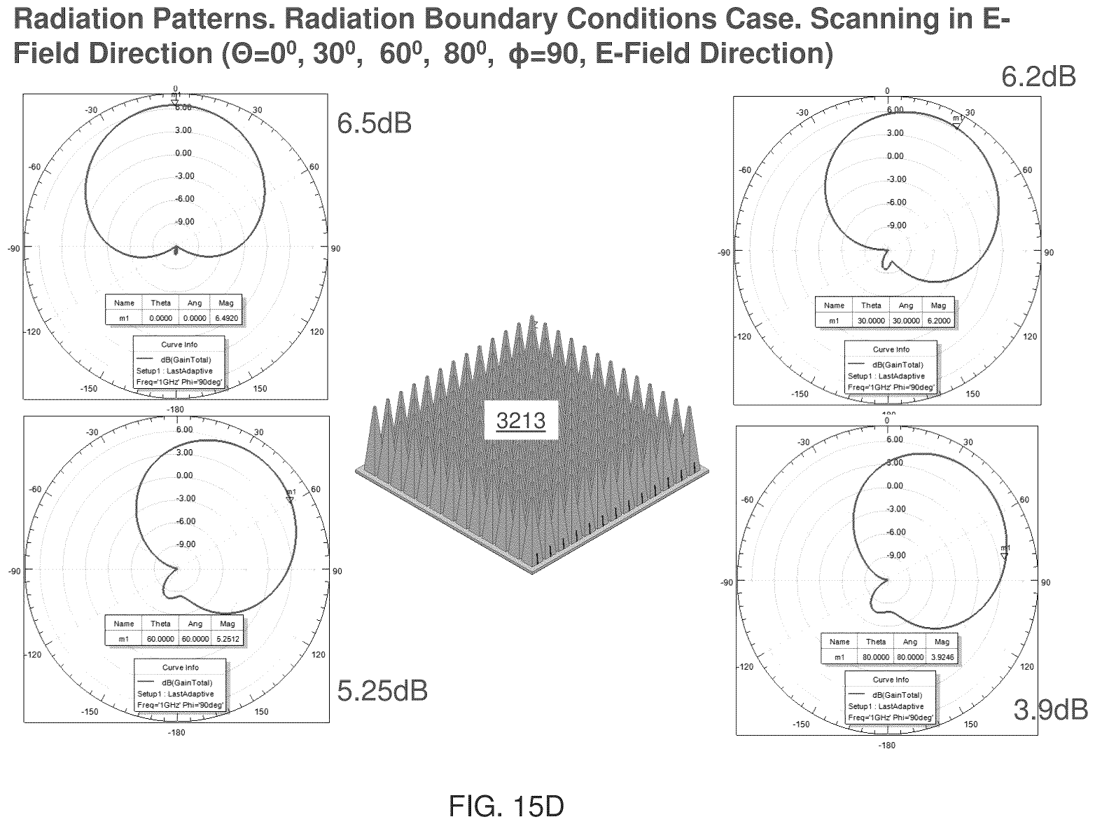

With reference now to FIGS. 2A-2C in combination with FIGS. 1A-1D, in an embodiment the 3D shape (3150) of each DRA (3100′) has overall outside footprint dimensions, a and b, at the proximal end (3102), and an overall height, H, from the proximal end (3102) to the distal end (3104), where H is greater than a, or H is greater than b, alternatively, H is greater than a, and H is greater than b. In an embodiment, H is equal to or greater than three times a, or H is equal to or greater than three times b, alternatively, H is equal to or greater than three times a, and H is equal to or greater than three times b. In an embodiment, the relationship between H, a, and α, is defined by, TAN(α)=a/(2H) (best seen with reference to FIG. 1D). In the embodiment of FIGS. 2A-2C, the DRA subarray (3000) has an overall footprint (3300) with x, y dimensions of 1 mm×1 mm that is within a λ/2×λ/2 subarray size suitable for use at 140 GHz. In an embodiment, the proximal end (3102) of the DRA subarray (3000) has a ground plane or ground surface (6500), which in an embodiment includes a plurality of slotted apertures (slots) (6502) (four illustrated, but only two denoted as representational) disposed and configured to couple an EM signal from an EM source (6000) (see FIGS. 4A, 4B, and 15B, for example) to each DRA (3100′) of the plurality of DRAs (3100).

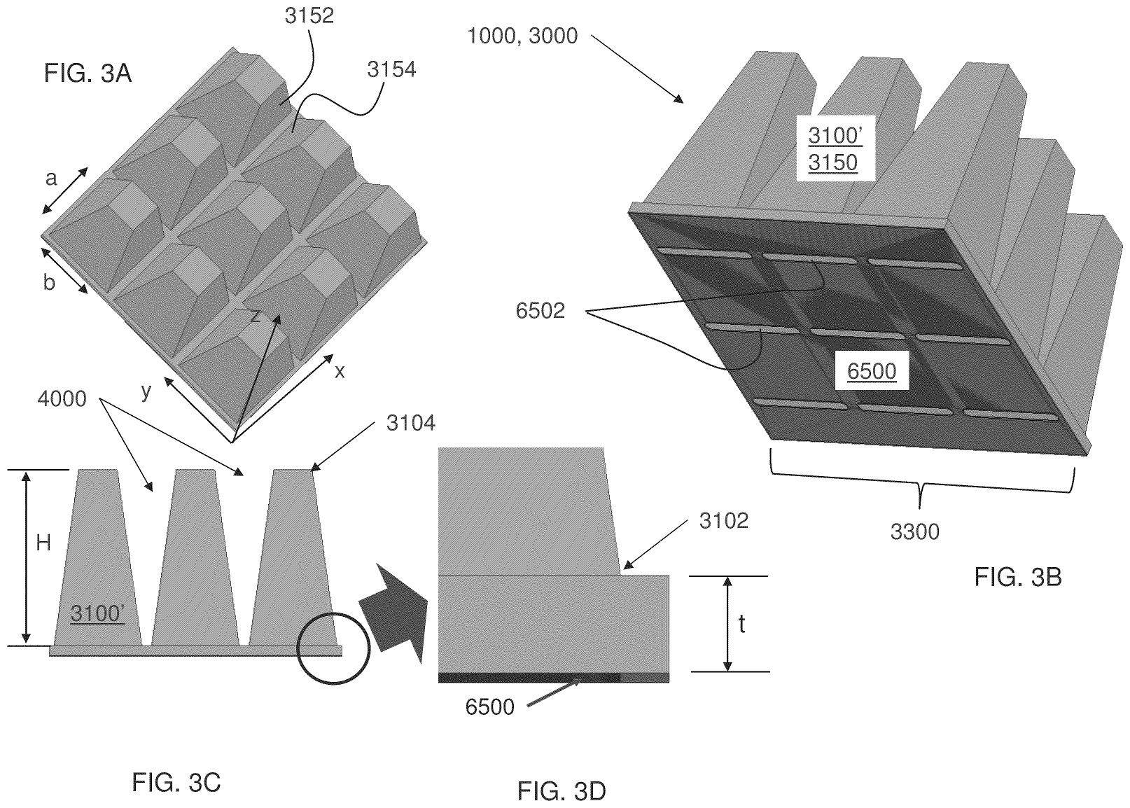

With reference now to FIGS. 3A-3D in combination with FIGS. 1A-1D, and similar to FIGS. 2A-2C, in an embodiment the 3D shape (3150) of each DRA (3100′) has overall outside footprint dimensions, a and b, at the proximal end (3102), and an overall height, H, from the proximal end (3102) to the distal end (3104), where H is greater than a, or H is greater than b, alternatively, H is greater than a, and H is greater than b. In an embodiment, H is equal to or greater than three times a, or H is equal to or greater than three times b, alternatively, H is equal to or greater than three times a, and H is equal to or greater than three times b. In an embodiment, the relationship between H, a, and α, is defined by, TAN(α)=a/(2H) (best seen with reference to FIG. 1D). In the embodiment of FIGS. 3A-3D, the DRA subarray (3000) has an overall footprint (3300) with x, y dimensions that are within a λ/2×λ/2 subarray size suitable for use at 140 GHz. In an embodiment, the proximal end (3102) of the DRA subarray (3000) has a ground plane or ground surface (6500), which in an embodiment includes a plurality of slotted apertures (slots) (6502) (nine illustrated, but only two denoted as representational) disposed and configured to couple an EM signal from an EM source (6000) (see FIGS. 4A, 4B, and 15B, for example) to each DRA (3100′) of the plurality of DRAs (3100). Also, the 3D shape (3150) of each DRA (3100′) has a faceted surface (3152) that faces another faceted surface (3154) of an adjacent one of the plurality of DRAs (3100). The shape and tapered spacing of the faceted surfaces relative to each other serve to define the non-DRA space (4000) in which the E-field, when present, is guided and propagates. In the embodiment depicted in FIGS. 3A-3D, each DRA (3100′) of the plurality of DRAs (3100) are disposed and configured to operate at 140 GHz with a height H equal to or greater than 0.6 mm and equal to or less than 0.8 mm.

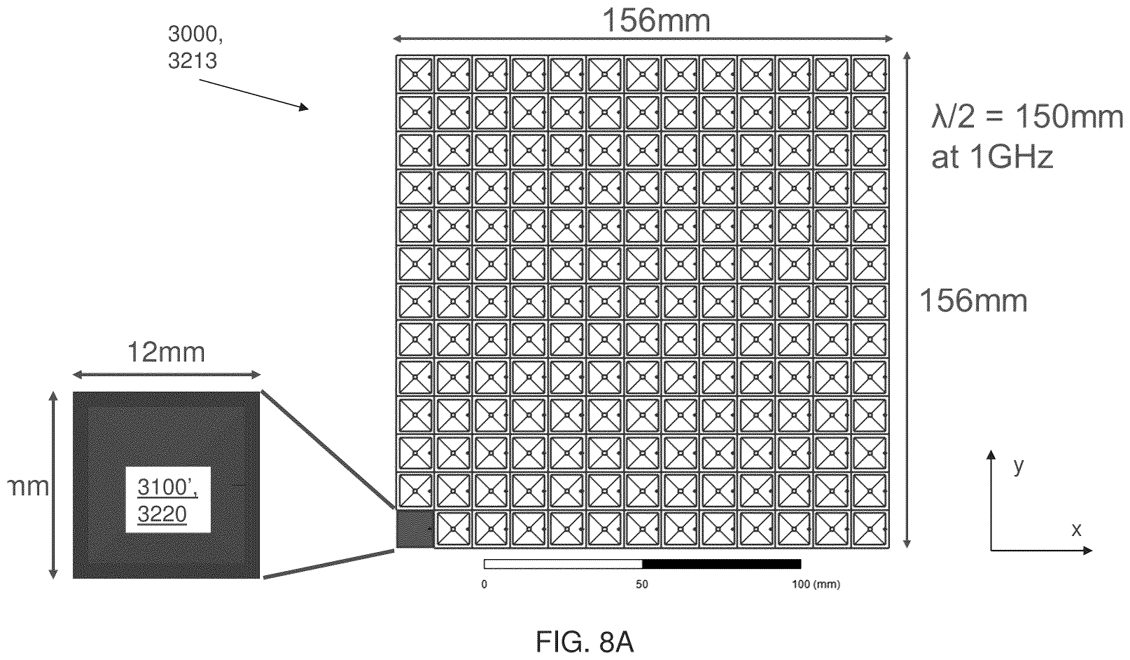

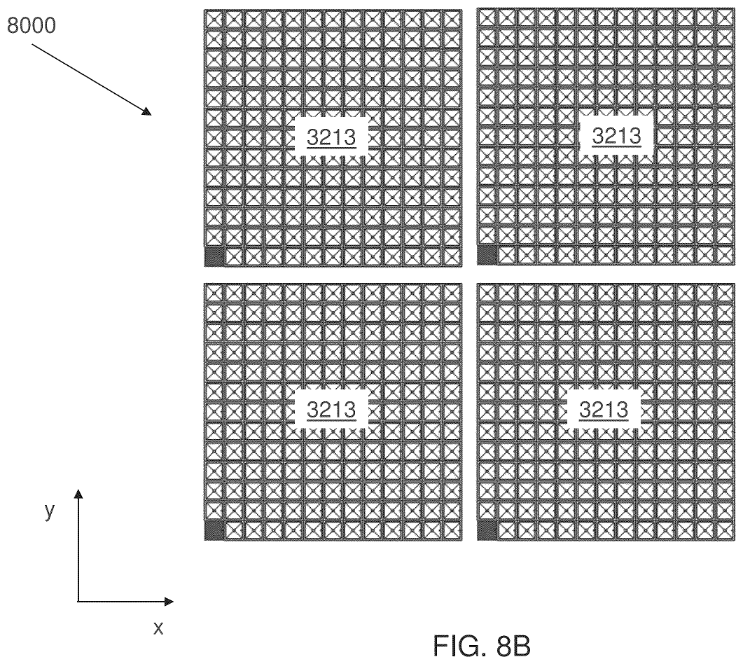

With reference now to FIGS. 2A-2C and 3A-3D, in an embodiment, and as illustrated herein, the unit cell (3200) of a given DRA subarray (3000) is at least a 2×2 array (3204) of the plurality of DRAs (3100), alternatively, the unit cell (3200) is at least a 3×3 array (3209) of the plurality of DRAs (3100), further alternatively, the unit cell (3200) is a 13×13 array (3213) of the plurality of DRAs (3100) (best seen with reference to FIG. 8A discussed further herein below). While certain sized arrays of the plurality of DRAs (3100) are illustrated herein, it will be appreciated that the scope of disclosure herein of such EM devices (1000) is not so limited, and that any size array falling within the ambit of the appended claims is contemplated and considered to be inherently disclosed herein. In an embodiment, the DRA subarray (3000), whether it comprises a 2×2 array (3204), a 3×3 array (3209), a 13×13 array (3213), or any other sized array falling within an ambit of the appended claims, is a monolithic construct that includes the integrally formed base 3050 having a thickness t that is relatively thin as compared to H to form a connected-DRA subarray (also herein referred to by reference numeral 3000) (best seen with reference to FIG. 3D). In an embodiment, t is greater than zero and equal to or less than H/5, alternatively t is greater than zero and equal to or less than H/10, further alternatively t is greater than zero and equal to or less than H/15. In an embodiment, the integrally formed unitary construct of the plurality of DRAs (3100) and the base (3050) is herein referred to as connected-DRAs (3000).

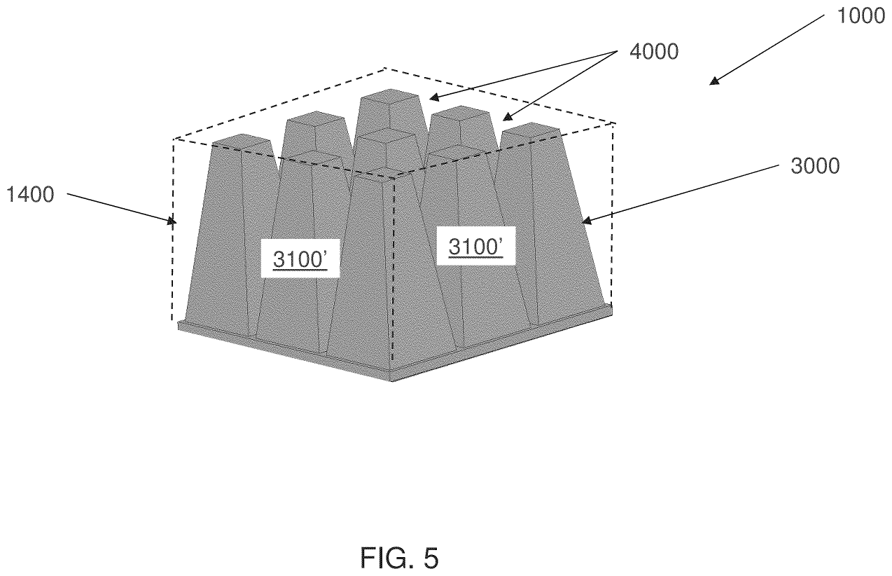

With reference now to FIGS. 4A and 4B, the DRA subarray (3000) is structurally configured to guide an E-field (5000), when present in the EM device (1000), in the non-DRA space (4000) between each DRA (3100′) of the plurality of DRAs (3100). In an embodiment, a direction of EM radiation (5500), when present in the EM device (5000), is directed from the proximal end (3102) of each DRA (3100′) toward the distal end (3104) of each DRA (3100). In such an embodiment, the high Dk of each DRA (3100′) acts like a waveguide, with the energy of the E-field (5000) being concentrated in the non-DRA space (4000). With reference to FIG. 5 in combination with FIGS. 3A-3D, in an embodiment an encapsulant (1400) is disposed encapsulating the DRA subarray (3000) and the non-DRA space (4000) between each adjacent DRA (3100′) of the plurality of DRAs (3100). In an embodiment, the encapsulant (1400) comprises a dielectric material. In an embodiment, the dielectric material of the encapsulant (1400) has a Dk value greater than 1 and equal to or less than 5, alternatively equal to or greater than 2 and equal to or less than 4.

With reference to FIG. 5 in combination with FIGS. 3A-3D, in an embodiment an encapsulant (1400) is disposed encapsulating the DRA subarray (3000) and the non-DRA space (4000) between each adjacent DRA (3100′) of the plurality of DRAs (3100). In an embodiment, the encapsulant (1400) comprises a dielectric material. In an embodiment, the dielectric material of the encapsulant (1400) has a Dk value greater than 1 and equal to or less than 5, alternatively equal to or greater than 2 and equal to or less than 4.

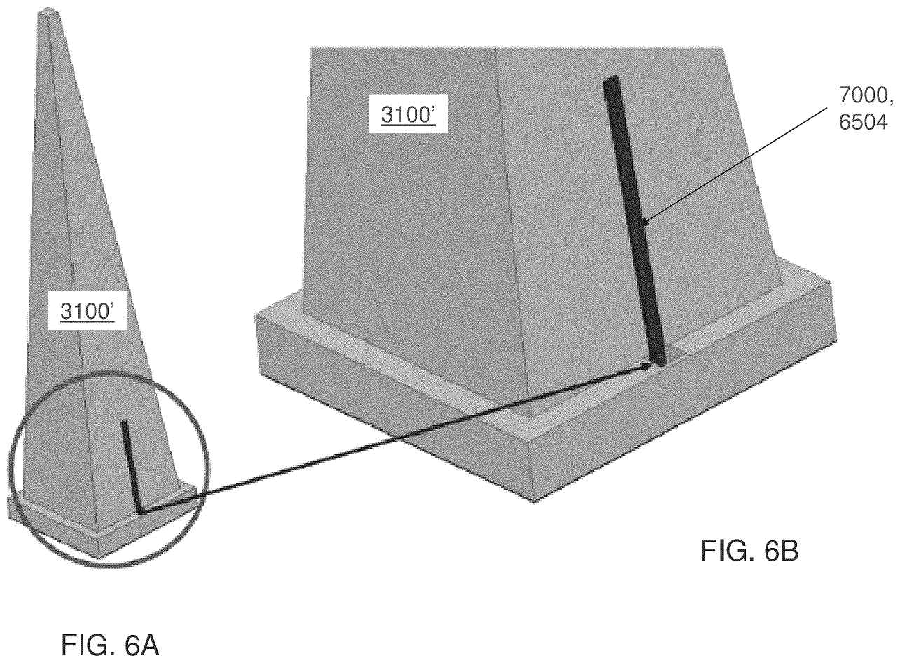

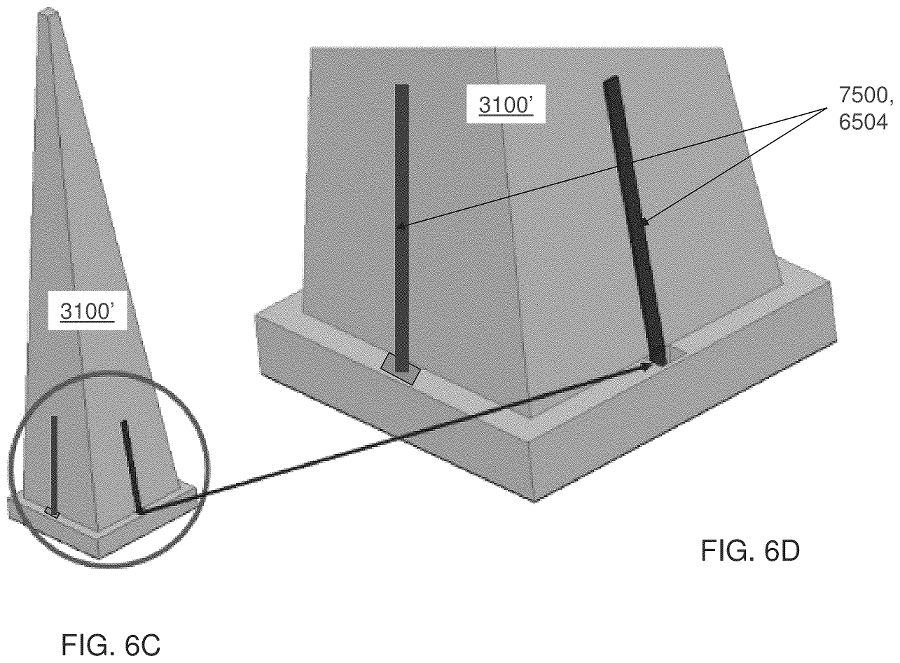

Reference is now made to FIGS. 6A-6B, which depict rotated isometric various views of a single DRA (3100′) as depicted in FIG. 1A, and portions thereof, including a signal feed (7000), which in an embodiment is one of a plurality of signal feeds (7000) disposed in a one-to-one relationship with a respective one of the plurality of DRAs (3100).

In an embodiment and with reference now to FIGS. 6C-6D, a plurality of signal feeds (7500) are disposed in a two-to-one relationship with a respective one of the plurality of DRAs (3100) forming a pair of the plurality of signal feeds (7500), wherein each pair of the plurality of signal feeds (7500) for each respective DRA (3100′) of the plurality of DRAs (3100) are disposed to electromagnetically excite the respective DRA (3100′) in two different directions. As depicted in FIGS. 6C-6D, each pair of the plurality of signal feeds (7500) for each respective DRA (3100′) of the plurality of DRAs (3100) are disposed to electromagnetically excite the respective DRA (3100′) in two orthogonal directions.

As depicted in FIGS. 6A-6D, each signal feed (7000, 7500) of the plurality of signal feeds is depicted being a signal wire (6504). However, such signal feeds can be constructed as a slotted aperture (6502).

With reference now to FIG. 7, which depicts the plurality of DRAs (3100) having a 3D triangular pyramid shape (3170), and one of a plurality of signal feeds (7000) disposed in a one-to-one relationship with a respective one of the plurality of DRAs (3100), it is contemplated, while not being held to any particular theory, that the edge (3172) of the triangular pyramid shape (3170) opposite the corresponding signal feed (7000) of the 3D triangular pyramid shape (3170) for each respective DRA (3100′) of the plurality of DRAs (3100) is disposed relative to and in combination with the corresponding signal feed (7000) to electromagnetically excite the respective DRA (3100′) to facilitate the generation of circular polarization of the E-field (5000), when present in the EM device (1000), in the non-DRA space (4000) between each DRA (3100′) of the plurality of DRAs (3100). The finer structure of the 3D triangular pyramid shape (3170) is well suited for low frequency applications as disclosed herein, as the manufacturing tolerances are manageable at such sizes and frequencies.

In an embodiment, each of the foregoing signal feeds (7000) (7500) is centrally disposed relative to a corresponding faceted surface (3154) (3174) of the corresponding DRA (3100′).

Reference is now made to FIGS. 8A-8B.

FIG. 8A depicts a top down plan view of the 13×13 DRA subarray (3213) of the same, or similar, DRA subarray (3000) depicted in FIG. 1A, with an artistic representation of a single DRA (3100′) being a pixel-like feature (3220) of the DRA subarray (3213). In an embodiment, the 13×13 DRA subarray (3213) has an overall footprint with x, y dimensions of x=156 mm, y=156 mm, where λ/2 at 1 GHz is 150 mm, and each pixel (3220) has x, y dimensions of x=12 mm, y=12 mm. In an embodiment, the 13×13 DRA subarray (3213) has a Dk value of 190.

FIG. 8B depicts a top down plan view of four 13×13 DRA subarrays (3213) depicted in FIG. 8A arranged in an x-by-y array (depicted as a 2×2 array) (8000). While only a 2×2 array of the subarrays (3213) is depicted in FIG. 8B, it will be appreciated that this is for illustrative purposes only, and that a scope of an invention presented in the appended claims is not so limited. As such, it will be appreciated that a plurality of any of the foregoing descriptions of the EM device (1000) can be arranged to form an x-by-y array (8000) of a plurality of the DRA subarray (3000).

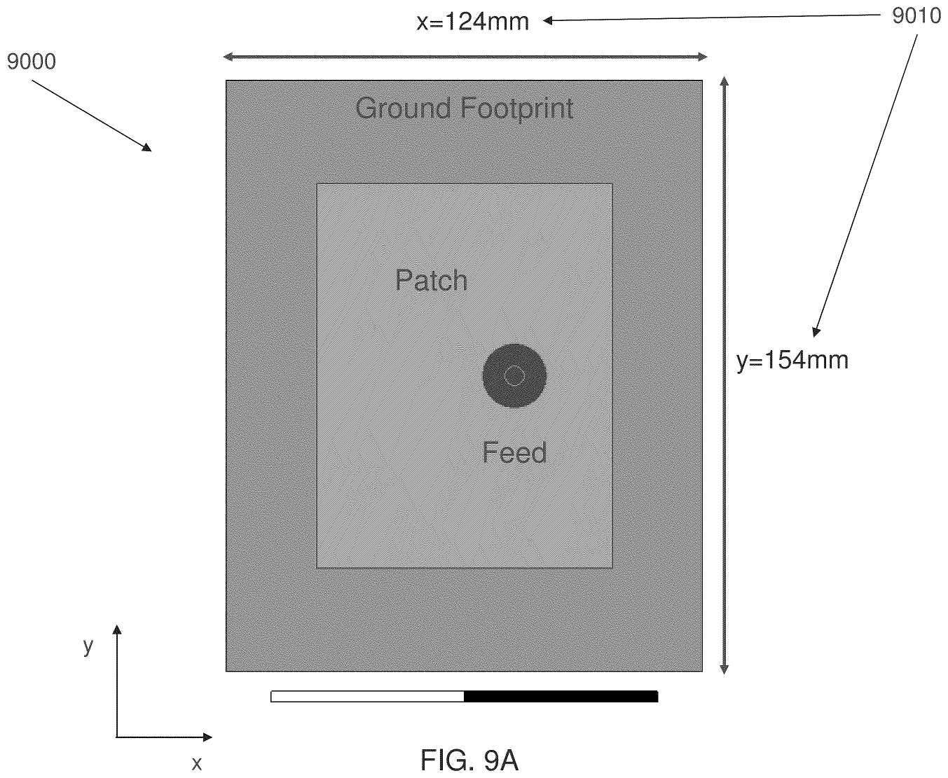

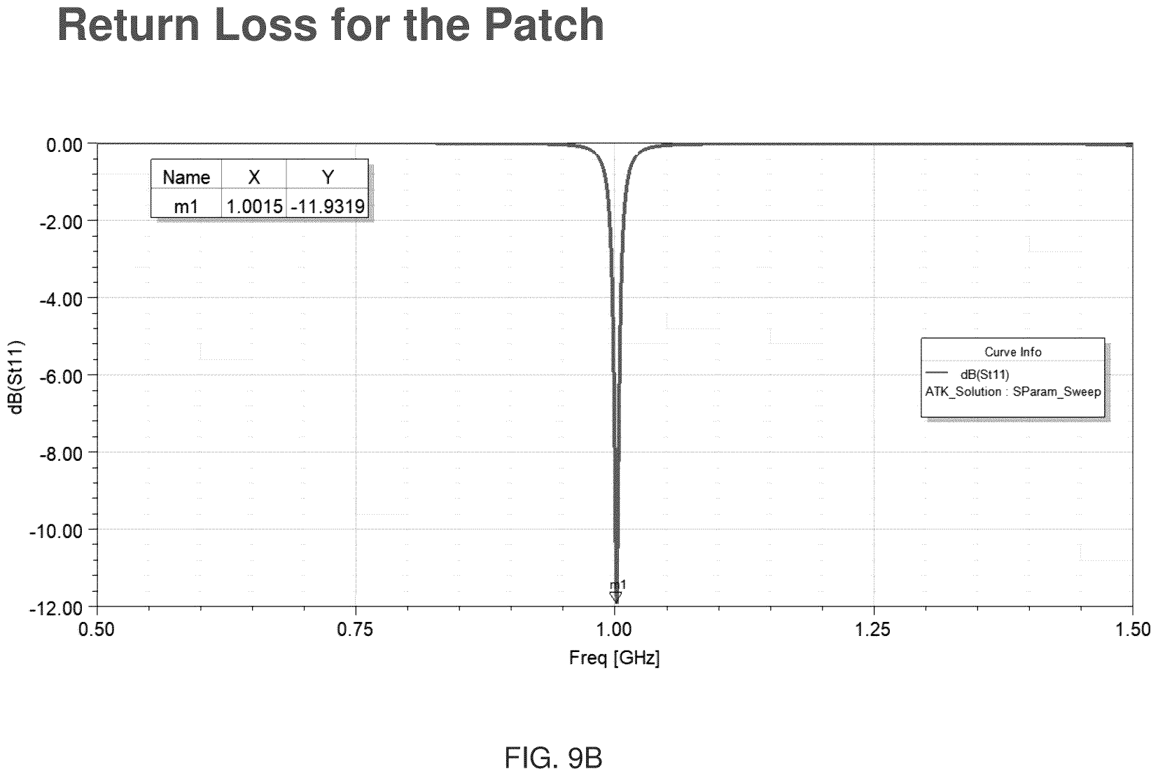

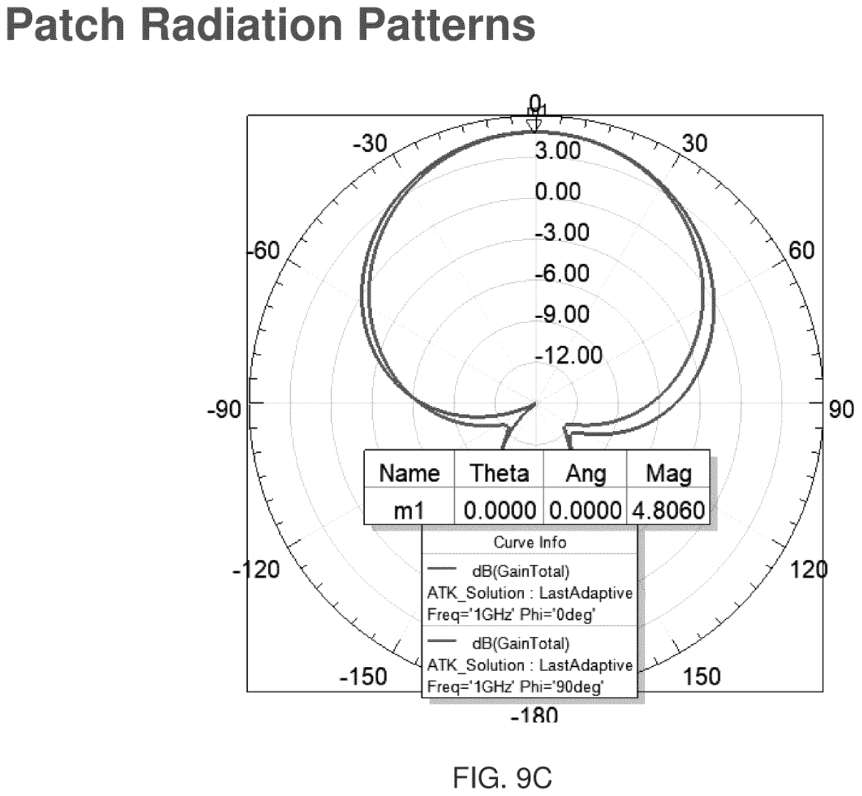

As a comparison of performance versus size between a prior art patch antenna and an antenna as disclosed herein, reference is now made to FIGS. 9A-9C, 10, and 11A-11C.

FIG. 9A depicts an analytical model of example patch antenna (9000) with a ground plane footprint (9010) of x=124 mm and y=154 mm, which is considered suitable for a 1 GHz application with λ/2=150 mm; FIG. 9B depicts analytically modeled return loss characteristics (−12 dBi) for the patch antenna (9000) of FIG. 9A at a center frequency of 1 GHz; and, FIG. 9C depicts analytically modeled radiation pattern characteristics (boresight gain of 4.8 dBi) for the same patch antenna (9000) of FIG. 9A at a center frequency of 1 GHz.

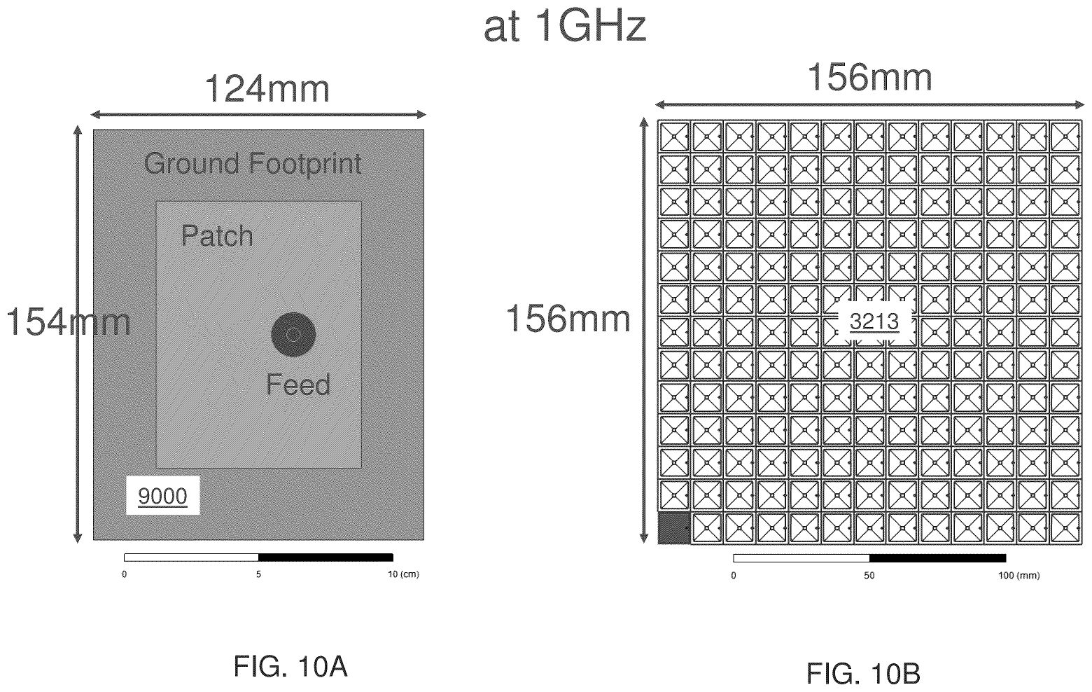

FIGS. 10A and 10B depict in a side by side comparison of the example patch antenna of FIG. 9A, and the 13×13 DRA subarray (3213) of FIGS. 1A, 4A, and 8A, where both devices are herein considered to be suitable for operation at 1 GHz with a λ/2 footprint for comparative purposes.

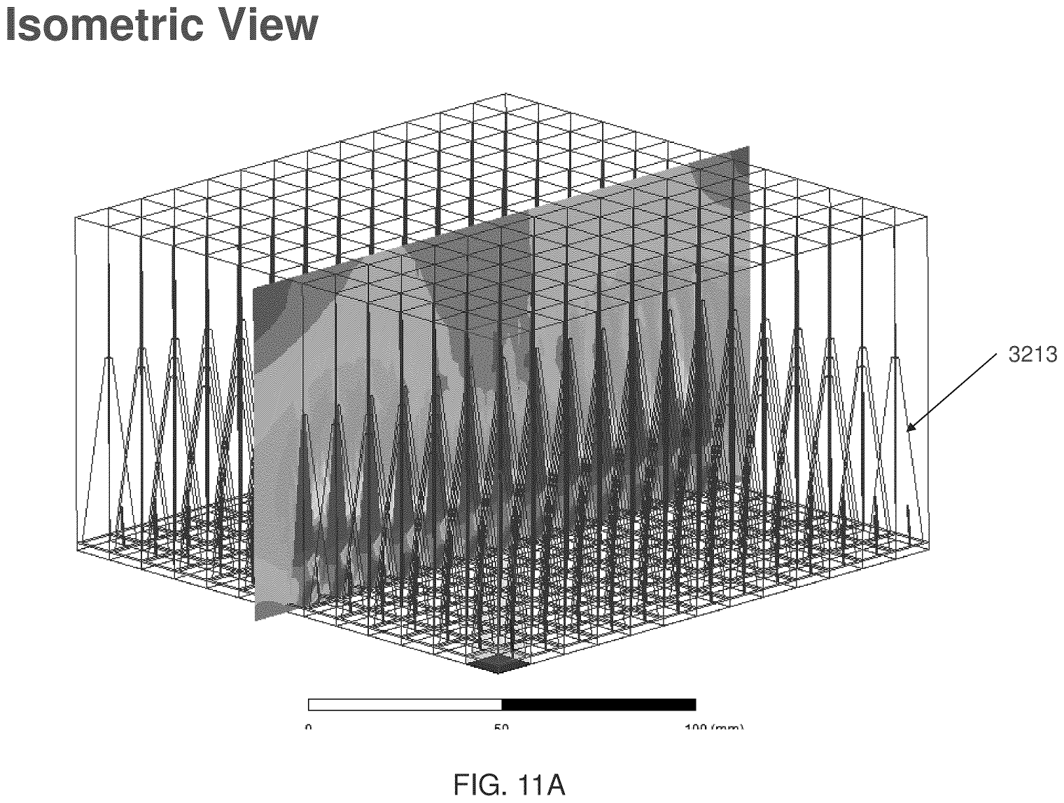

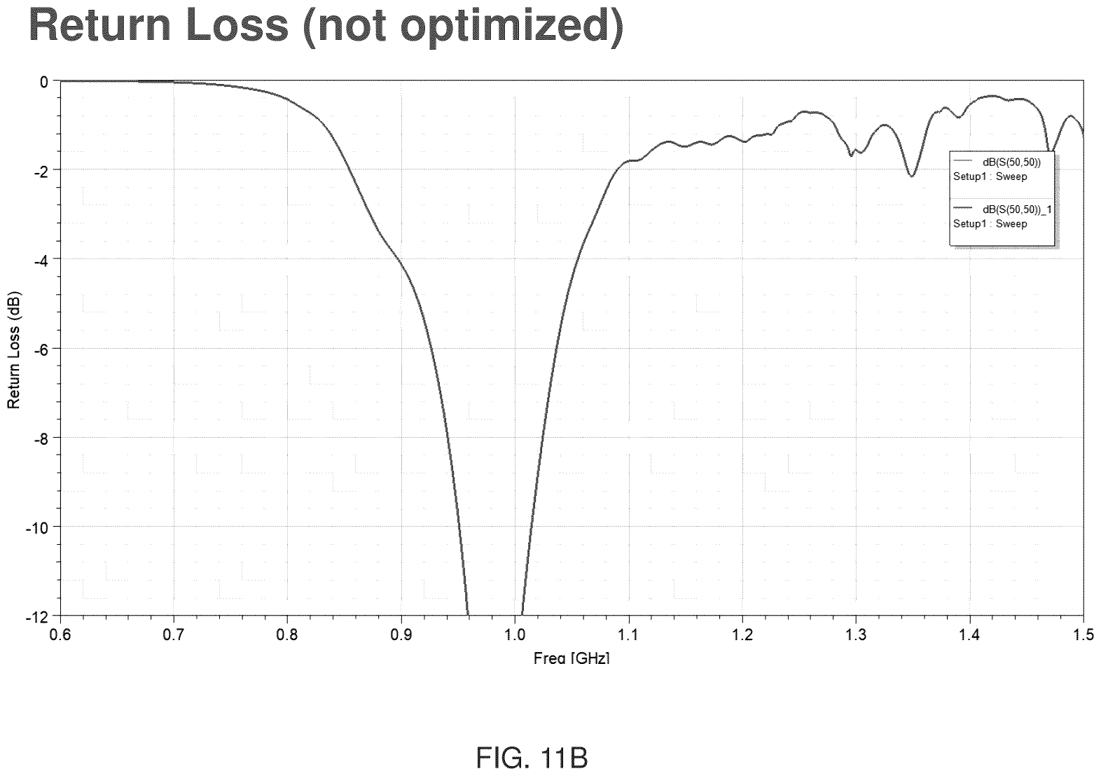

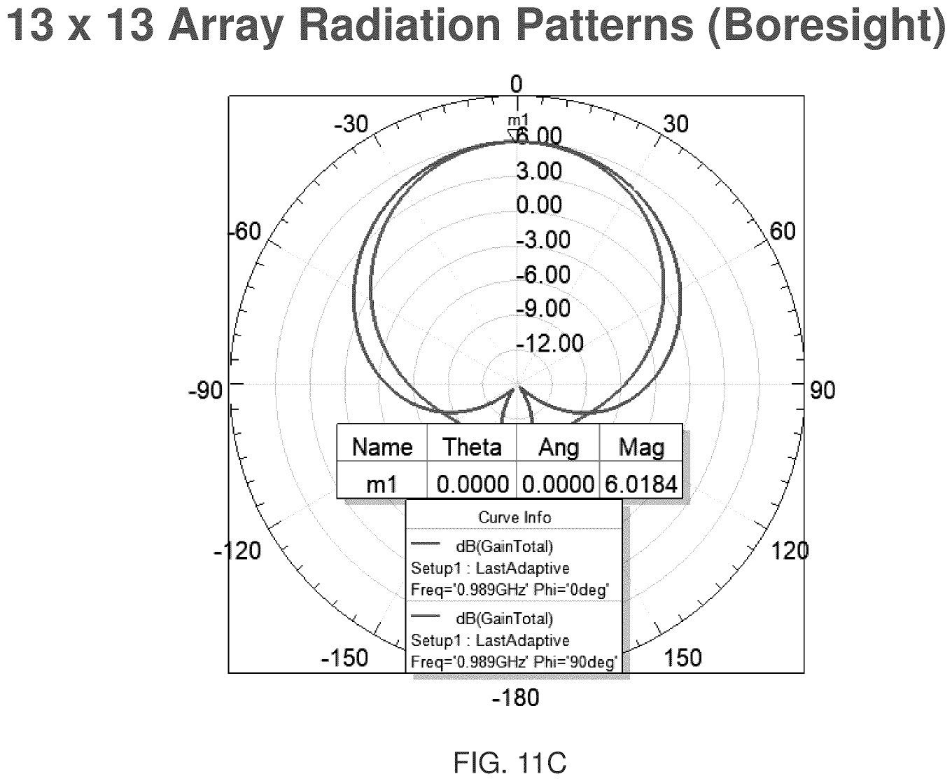

FIG. 11A depicts analytically modeled E-field energy propagation within the non-DRA spaces (4000) of the 13×13 DRA subarray (3213) of FIGS. 1A, 4A, 8A, and 10B (see also FIGS. 4A-4B for an alternative view of the E-field energy propagation).

FIG. 11B depicts analytically modeled return loss characteristics (greater than −12 dBi) for the 13×13 DRA subarray (3213) of FIG. 11A (compare with FIG. 9B for the patch antenna (9000)); and FIG. 11C depicts analytically modeled radiation pattern characteristics (boresight gain of 6 dBi) for the same 13×13 DRA subarray (3213) of FIG. 11A (compare with FIG. 9C for the patch antenna (9000)). While it is noted in FIG. 11B that optimization of the 13×13 DRA subarray (3213) is still contemplated, it can still be seen by making the above noted comparisons that the 13×13 DRA subarray (3213) has improved return loss and gain as compared to the prior art patch antenna (9000), while providing improvements as disclosed herein (e.g., beam shaping and steering).

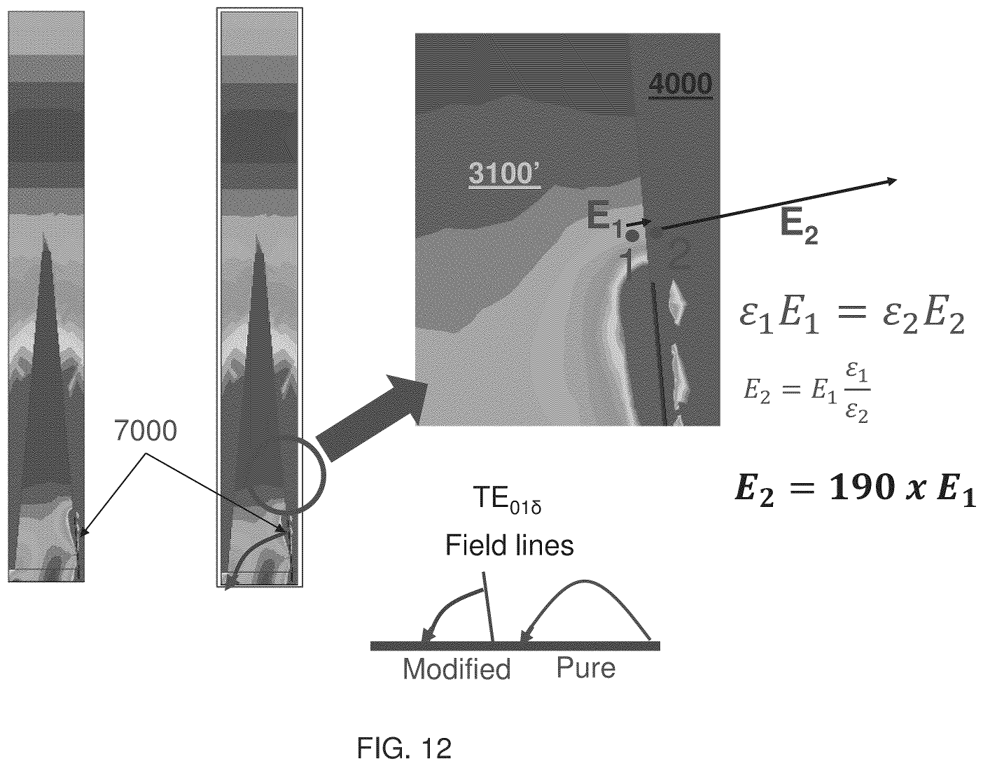

FIG. 12 depicts various views of the single DRA (3100′) of FIG. 1B with associated analytical E-field distribution characteristics for a given radiation periodic boundary condition to illustrate E-field energy and density being substantially higher outside of the DRA (3100′) in the non-DRA space (4000), as compared to the E-field energy and density within the material of the DRA (3100′). In the embodiment represented by FIG. 12, the radiation mode is modified TE_{01δ}, which is a result of the presence and placement of the signal feed (7000) on the faceted surface (3152) of the DRA (3100′), as compared to a pure TE₀₁ mode that does not originate from such a signal feed (7000). As depicted, the E-field (E2) in the non-DRA space (4000) is 190×E1 (the E-field in the DRA (3100′)), where ϵ1=190, and ϵ2=1 (air), illustrating that the E-field energy and density is concentrated in the non-DRA space (4000) between the plurality of DRAs (3100), and not in the DRA's (3100′) themselves.

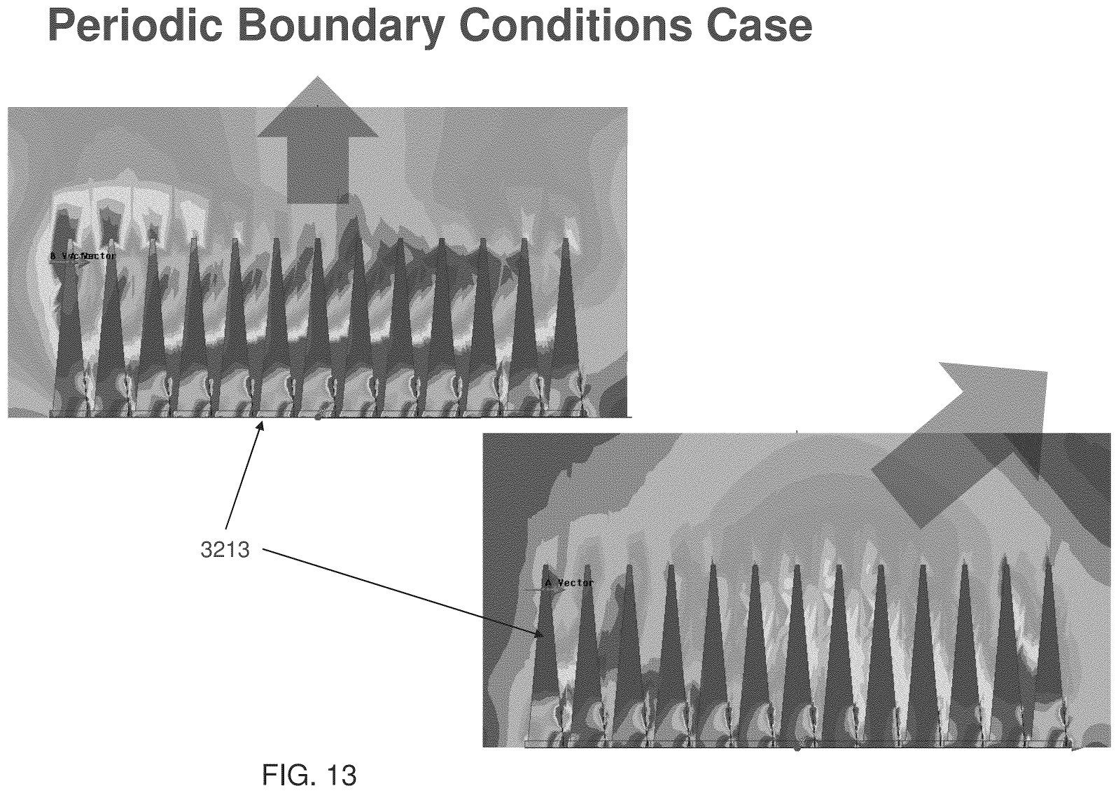

FIG. 13 depicts two views of analytical E-field distribution characteristics for the 13×13 DRA subarray (3213) of FIG. 11A, for two different radiation periodic boundary conditions to illustrate controlled beam steering capabilities of the direction of EM radiation.

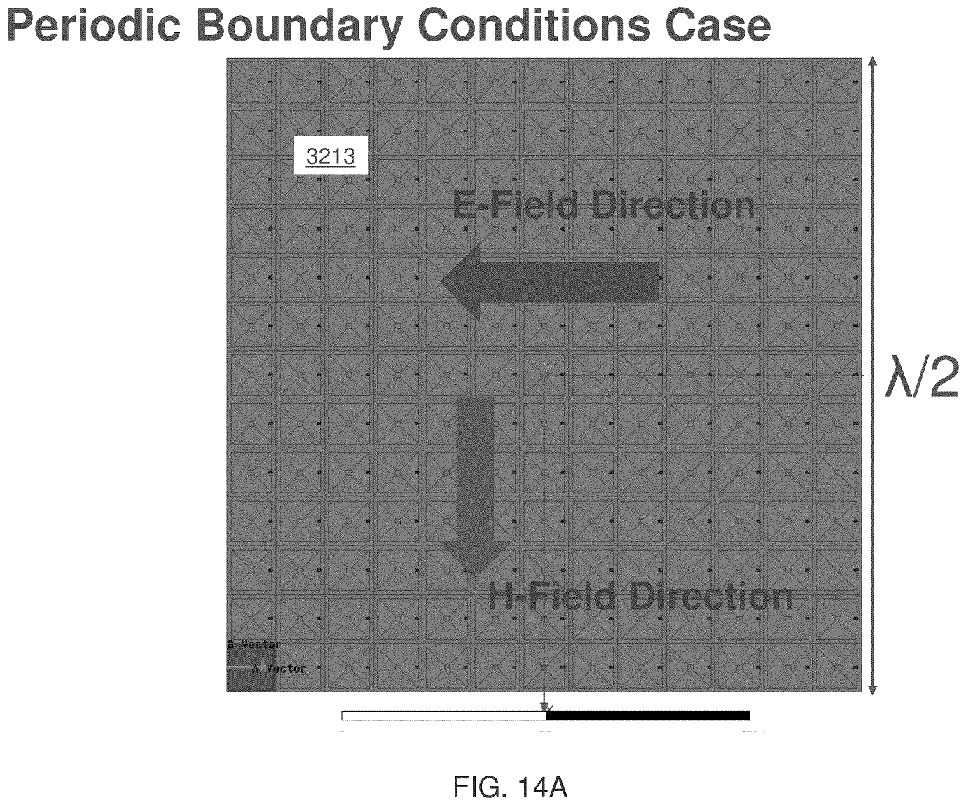

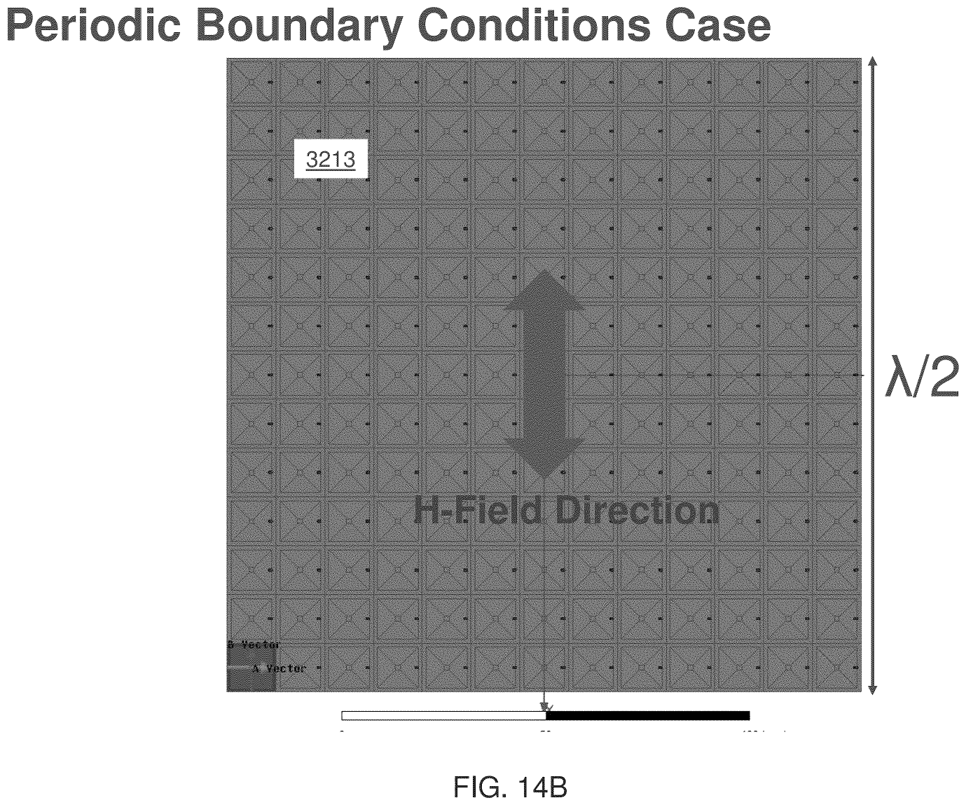

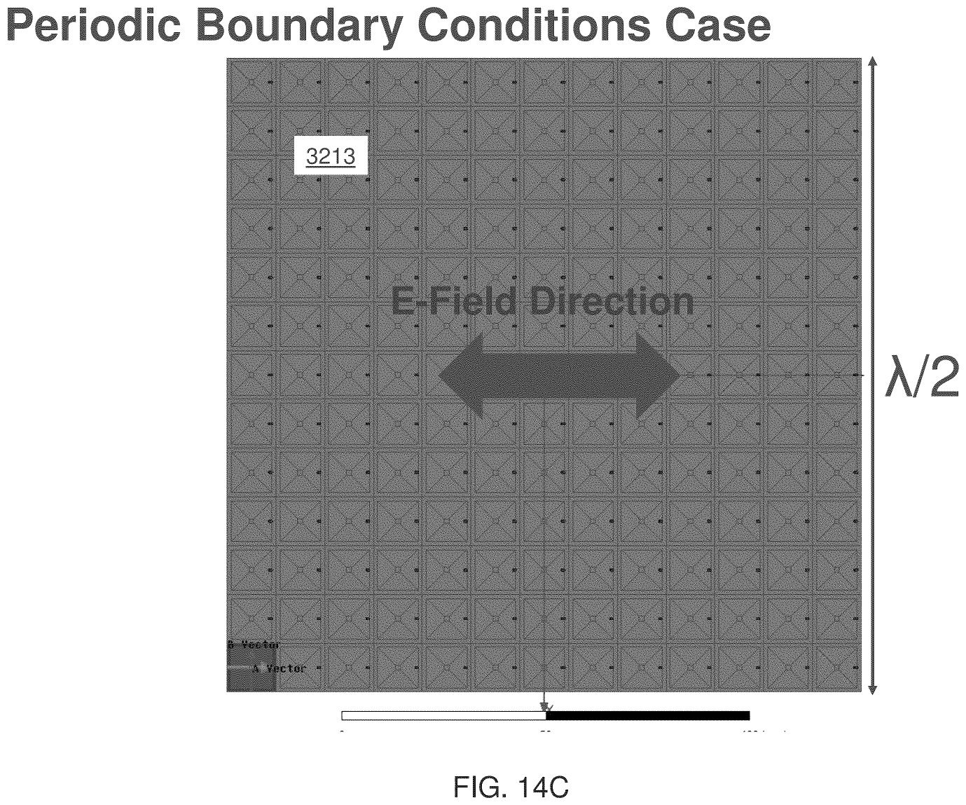

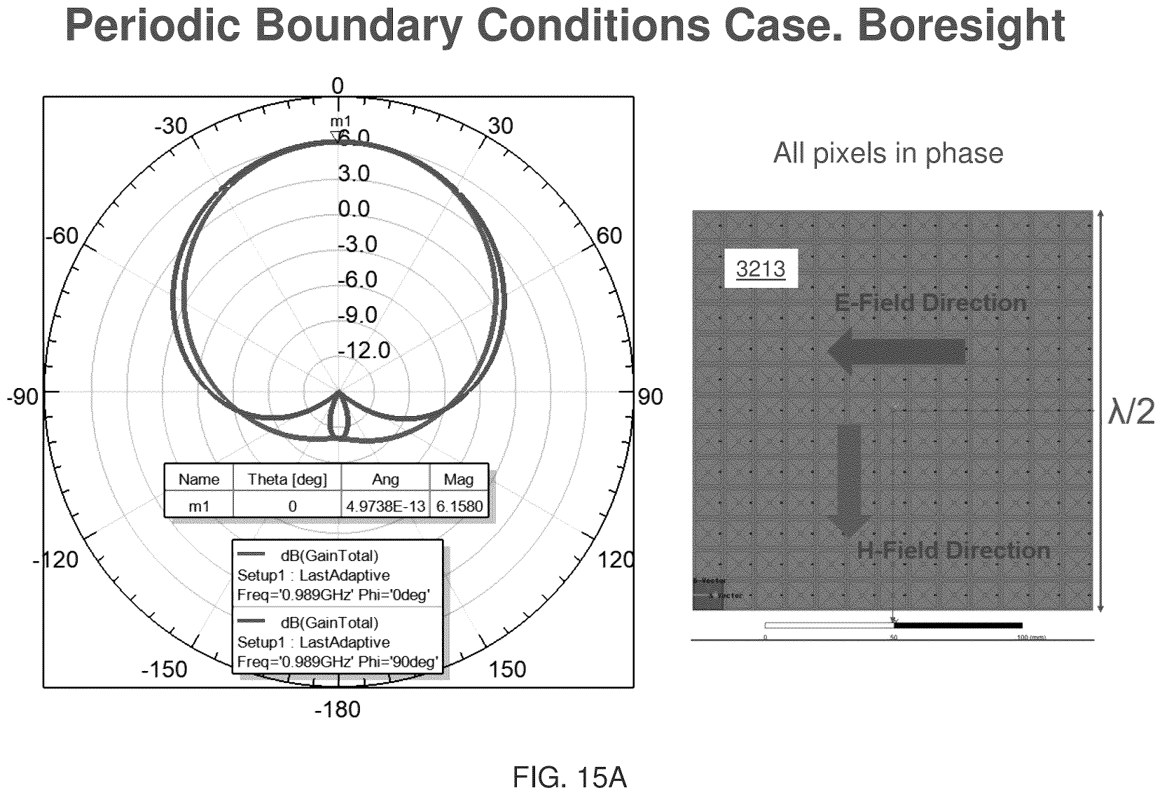

FIGS. 14A, 14B, and 14C, depict various radiation periodic boundary conditions for analytical simulations of the 13×13 DRA subarray (3213) having a λ/2×λ/2 footprint (3300), and FIGS. 15A, 15B, 15C, and 15D, depict analytical modeling results for various radiation periodic boundary conditions relating to the conditions depicted in FIGS. 14A, 14B, and 14C. As can be seen from the various analytical simulations, an embodiment of the EM device (1000) disclosed herein is capable of beam steering within a λ/2×λ/2 footprint (3300). A review of the EM radiation distribution characteristics depicted in FIGS. 15A-15D shows acceptable H-field direction gains (ϕ=0 deg) of 6.15 dBi, 5.8 dBi, 4.57 dBi, and 3.1 dBi, at θ=0 deg, 30 deg, 60 deg, and 80 deg, respectively (see FIG. 15B for example); and shows acceptable E-field direction gains (ϕ=90 deg) of 6.5 dBi, 6.2 dBi, 5.25 dBi, and 3.9 dBi, at θ=0 deg, 30 deg, 60 deg, and 80 deg, respectively (see FIG. 15D for example). The analytically-derived EM gains achieved show the EM device (1000) to be productive of a wide field of view, FOV, with a small aperture (λ/2×λ/2) at high frequency (1 GHz for example), which is not achievable to the same degree in a patch antenna. It is known that a single patch (λ/2×λ/2) antenna cannot provide beam forming, since the radiation pattern of a single patch is fixed and unchanged. To the contrary and as disclosed herein, a 13×13 array or even a 3×3 array within the same footprint (λ/2×λ/2) can provide beam forming because it has many elements that can radiate independently. If the rows or columns are properly excited, they can provide beam steering, something that is not possible with a single patch.

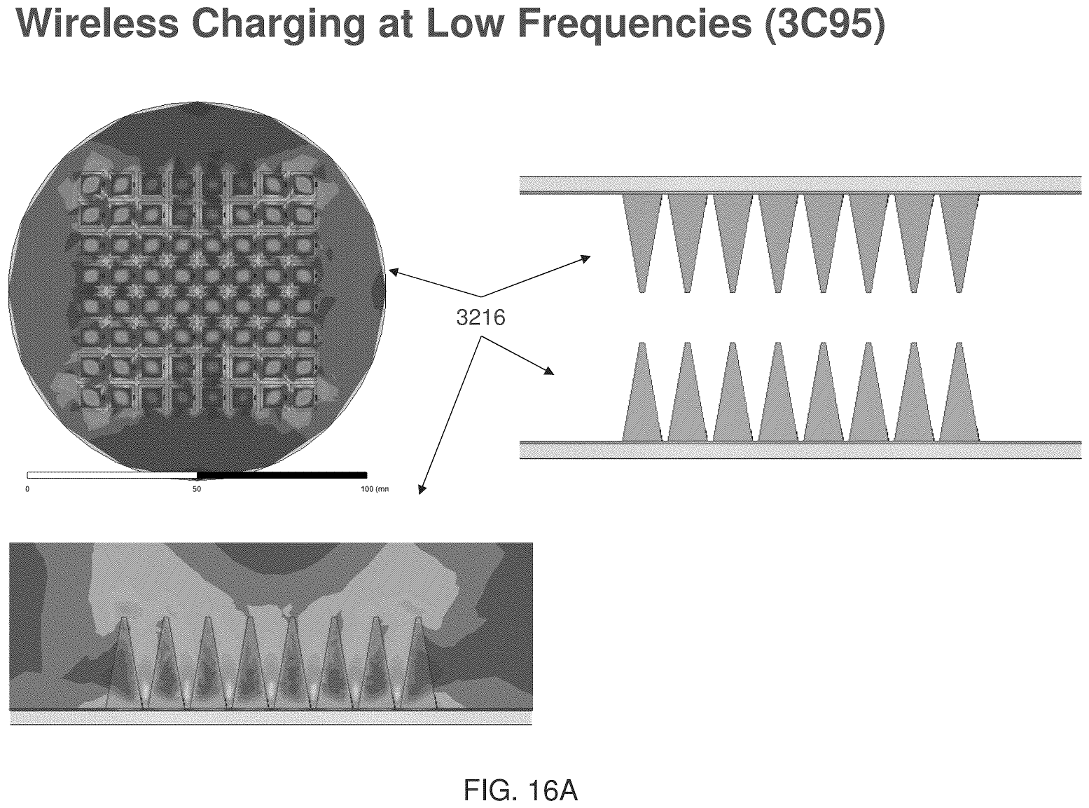

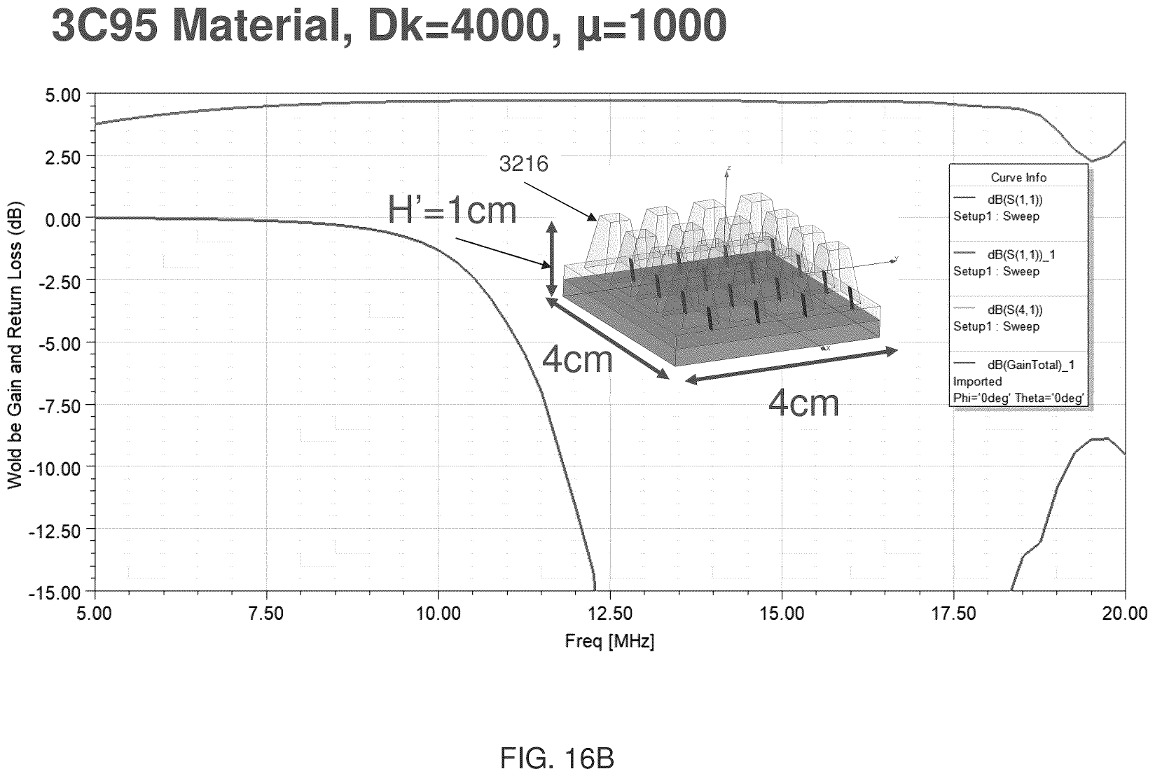

FIGS. 16A and 16B depict similar structure to that disclosed in FIGS. 1A-15D, with analytical simulation characteristics for the E-field distribution, suitable for wireless charging at low frequencies. In the embodiment depicted, the DRA subarray is an 8×8 DRA subarray (3216) with Dk=4000 and u=1000, a footprint (3300) of 4 cm×4 cm, a height H′ of the package (DRA subarray and excitation substrate) equal to 1 cm, and being configured for operation at a center frequency of 15 MHz. In an embodiment, the height H of an individual DRA (3100′) for subarray (3216) is 6 mm, as compared to 50 mm for a DRA (3100) in subarray (3000). An example material for use in the Embodiment of FIGS. 16A-16B is 3C95, available from the Yageo Group.

As used herein, the term “unitary,” “monolith,” or “monolithic,” for example, is a unitary component or a monolith or monolithic structure, refers to a three-dimensional construction, e.g., one body, that can be formed from portions that can have substantially identical or identical compositions. A monolith can be made of a single, continuous material, e.g., thermoplastic material, and can be manufactured using various techniques, including injection molding, compression molding, extrusion, 3D printing, and additive manufacturing. Accordingly, a unitary component differs from a laminate or assembly of differing constituents, which includes an interface between differing constituents thereof. A unitary component can be integrally formed, for example, integrally molded in a single mold. Similarly, as used herein, portions can be “integrally formed,” or one portion can be “integrally formed” with a different portion, resulting in a unitary component differing from a laminate or assembly of differing constituents, which includes an interface between differing constituents thereof.

While embodiments described and/or illustrated herein depict DRAs of a DRA subarray having a particular cross-section profile (x-y, x-z, or y-z), it will be appreciated that such profiles may be modified without departing from a scope of the invention. As such, any profile that falls within the ambit of the disclosure herein, and is suitable for a purpose disclosed herein, is contemplated and considered to be complementary to the embodiments disclosed herein.

An embodiment, as illustrated and/or described herein by the various figures and accompanying text, provides an EM device having a DRA subarray configured and structured to provide an E-Field that propagates within non-DRA space between adjacent ones of the DRAs of the DRA subarray. In an embodiment, the EM device is capable of being configured as an antenna subsystem for providing EM beam steering.

While the following example embodiments are individually presented, it will be appreciated from a complete reading of all of the embodiments described herein below that similarities may exist among the individual embodiments that would enable some cross over of features and/or processes. As such, combinations of any of such individual features and/or processes may be employed in accordance with an embodiment, whether or not such combination is explicitly illustrated, while remaining consistent with the disclosure herein. The several figures associated with one or more of the following example embodiments depict an orthogonal set of x-y-z axes that provide a frame of reference for the structural relationship of corresponding features with respect to each other, where an x-y plane coincides with a plan view, and an x-z or y-z plane coincides with an elevation view, of the corresponding embodiments.

As used herein, the phrase “having a Dk material other than air” necessarily includes a Dk material that is not air, but may also include air, which includes a foam. As used herein, the phrase “comprising air” necessarily includes air, but also does not preclude a Dk material that is not air, which includes a foam. Also, the term “air” may more generally be referred to and viewed as being a gas having a dielectric constant that is suitable for a purpose disclosed herein.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

With respect to the several figures of FIGS. 1A-16B, it will be appreciated that various aspects of an embodiment are disclosed herein, which are in accordance with, but not limited to, at least the following aspects and/or combinations of aspects.

Aspect 1 (see FIG. 1A for example): An electromagnetic, EM, device (1000) configured to be operational at a defined center frequency, f, having a free space wavelength, λ, the EM device comprising: a plurality of dielectric resonator antennas, DRAs, (3100) that can resonate at the same frequency, f, forming a unit cell (3200) having an overall footprint fx, fy of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100), the unit cell (3200) defining a DRA subarray (3000).

Aspect 2: The EM device (1000) of Aspect 1, wherein: the unit cell (3200) is a monolithic construct.

Aspect 3: The EM device (1000) of any one of Aspects 1 to 2, wherein: each DRA (3100′) of the plurality of DRAs (3100) is a solid, non-hollow, construct.

Aspect 4: The EM device (1000) of any one of Aspects 1 to 3, wherein: the unit cell (3200) is a dielectric-only construct.

Aspect 5: The EM device (1000) of any one of Aspects 1 to 3, wherein: the unit cell (3200) comprises a magneto-dielectric material.

Aspect 6: The EM device (1000) of any one of Aspects 1 to 5, wherein: each DRA (3100′) of the plurality of DRAs (3100) has a same 3D shape and size (3150).

Aspect 7: The EM device (1000) of Aspect 6, wherein: the 3D shape (3150) of each DRA (3100′) has a proximal end (3102) proximate a base (3202) of the unit cell (3200), the base (3202) being monolithic with each DRA (3100′), and an opposing distal end (3104) at a distance from the base (3202), the 3D shape (3150) tapering inward from the proximal end (3102) to the distal end (3104) to form and define non-DRA space (4000) between each adjacent DRA (3100′) of the plurality of DRAs (3100).

Aspect 8: The EM device (1000) of Aspect 7, wherein: the DRA subarray (3000) comprises a dielectric material having a first dielectric constant, Dk, value; and, the non-DRA space (4000) comprises a dielectric material having a second Dk value that is less than the first Dk value.

Aspect 9: The EM device (1000) of Aspect 8, wherein: the first Dk value is equal to or greater than 50 and equal to or less than 2,000, alternatively equal to or greater than 100 and equal to or less than 1,000; and, the second Dk value is equal to or greater than 1 and equal to or less than 5.

Aspect 10 (see FIGS. 1A-1C for example): The EM device (1000) of Aspect 7, wherein: the inwardly tapered 3D shape (3150) has a first effective dielectric constant, Dk, value at the proximal end (3102), and a second effective Dk value at the distal end (3104) that is less than the first effective Dk value; wherein the respective effective Dk value is defined by the Dk value associated with incremental and uniform 3D cross sectional slices (3510) in the z-direction of a non-tapered envelope (3500) that bounds both the 3D shape (3150) of the respective DRA (3100′) and the associated portion of non-DRA space (4000) about the respective DRA (3100′); wherein a thickness h of the 3D cross sectional slices (3510) in the z-direction is equal to or less than 10% of an overall height H of the respective DRA (3100′) in the z-direction.

Aspect 11: The EM device (1000) of Aspect 10, wherein: the first effective Dk value is equal to or greater than 8 and equal to or less than 16, alternatively equal to or greater than 16 and equal to or less than 100, further alternatively equal to or greater than 100 and equal to or less than 1000; and, the second effective Dk value is equal to or greater than 1 and equal to or less than 5, alternatively equal to or greater than 2.5 and equal to or less than 4.

Aspect 12 (see FIGS. 1A-1D for example): The EM device (1000) of any one of Aspects 7 to 11, wherein: the inwardly tapered 3D shape (3150) has a taper angle α of equal to or greater than 5-degrees and equal to or less than 35-degrees; alternatively, equal to or greater than 25-degrees and equal to or less than 30-degrees; alternatively, equal to or greater than 5-degrees and equal to or less than 20-degrees.

Aspect 13 (see FIGS. 2A-2C for example): The EM device (1000) of Aspect 12, wherein: the 3D shape (3150) of each DRA (3100′) has overall outside footprint dimensions, a and b, at the proximal end (3102), and an overall height, H, from the proximal end (3102) to the distal end (3104); and, H is greater than a, or H is greater than b; alternatively, H is greater than a, and H is greater than b.

Aspect 14: The EM device (1000) of Aspect 13, wherein: the relationship between H, a, and α, is defined by: TAN(α)=a/(2H).

Aspect 15: The EM device (1000) of Aspect 13, wherein: H is equal to or greater than three times a, or H is equal to or greater than three times b; alternatively, H is equal to or greater than three times a, and H is equal to or greater than three times b.

Aspect 16 (see FIGS. 3A-3C for example): The EM device (1000) of any one of Aspects 7 to 15, wherein: the 3D shape (3150) of each DRA (3100′) has a faceted surface (3152) that faces another faceted surface (3154) of an adjacent one of the plurality of DRAs (3100).

Aspect 17 (see FIGS. 4A-4B for example): The EM device (1000) of any one of Aspects 7 to 16, wherein: the DRA subarray (3000) is structurally configured to guide an E-field (5000), when present in the EM device (1000), in the non-DRA space (4000) between each DRA (3100′) of the plurality of DRAs (3100).

Aspect 18: The EM device (1000) of any one of Aspects 7 to 17, wherein: a direction of EM radiation (5500), when present in the EM device (5000), is directed from the proximal end (3102) of each DRA (3100′) toward the distal end (3104) of each DRA (3100).

Aspect 19 (see FIG. 5 for example): The EM device (1000) of any one of Aspects 1 to 18, further comprising: an encapsulant (1400) disposed encapsulating the DRA subarray (3000) and the non-DRA space (4000) between each adjacent DRA (3100′) of the plurality of DRAs (3100).

Aspect 20: The EM device (1000) of Aspect 19, wherein: the encapsulant (1400) comprises a dielectric material.

Aspect 21: The EM device (1000) of Aspect 20, wherein: the dielectric material of the encapsulant (1400) has a Dk value greater than 1 and equal to or less than 5, alternatively equal to or greater than 2 and equal to or less than 4.

Aspect 22: The EM device (1000) of any one of Aspects 1 to 21, wherein: f is equal to or greater than 50 KHz and equal to or less than 50 MHZ, alternatively f is equal to or greater than 1 GHz, and equal to or less than 1000 GHz.

Aspect 23: The EM device (1000) of any one of Aspects 1 to 22, wherein: the DRA subarray (3000) is at least a 2×2 array of the plurality of DRAs (3100) (see FIGS. 2A-2C for example); alternatively, the DRA subarray (3000) is at least a 3×3 array of the plurality of DRAs (3100) (see FIGS. 3A-3D for example); alternatively, the DRA subarray (3000) is at least a 13×13 array of the plurality of DRAs (3100) (see FIG. 1A for example).

Aspect 24 (see FIG. 1B for example): The EM device (1000) of any one of Aspects 1 to 23, wherein: each DRA (3100′) of the plurality of DRAs (3100) has a 3D rectangular pyramid shape (3160).

Aspect 25 (see FIG. 7 for example): The EM device (1000) of any one of Aspects 1 to 23, wherein: each DRA (3100′) of the plurality of DRAs (3100) has a 3D triangular pyramid shape (3170).

Aspect 26 (see FIGS. 6A-6B for example): The EM device (1000) of any one of Aspects 1 to 23, further comprising: a plurality of signal feeds (7000) disposed in a one-to-one relationship with a respective one of the plurality of DRAs (3100).

Aspect 27 (see FIGS. 6C-6D for example): The EM device (1000) of any one of Aspects 1 to 23, further comprising: a plurality of signal feeds (7500) disposed in a two-to-one relationship with a respective one of the plurality of DRAs (3100); wherein each pair of the plurality of signal feeds (7500) for each respective DRA (3100′) of the plurality of DRAs (3100) are disposed to electromagnetically excite the respective DRA (3100′) in two orthogonal directions.

Aspect 28 (see FIGS. 6C, 6D): The EM device (1000) of Aspect 24, further comprising: a plurality of signal feeds (7500) disposed in a two-to-one relationship with a respective one of the plurality of DRAs (3100) forming a pair of the plurality of signal feeds (7500); wherein each pair of the plurality of signal feeds (7500) for each respective DRA (3100′) of the plurality of DRAs (3100) are disposed to electromagnetically excite the respective DRA (3100′) in two orthogonal directions.

Aspect 29 (see FIG. 7): The EM device (1000) of claim 25, further comprising: a plurality of signal feeds (7000) disposed in a one-to-one relationship with a respective one of the plurality of DRAs (3100); wherein each signal feed of the plurality of signal feeds (7000) in combination with an opposing edge (3172) of the 3D triangular pyramid shape for each respective DRA (3100′) of the plurality of DRAs (3100) are disposed to electromagnetically excite the respective DRA (3100′) to facilitate circular polarization EM radiation.

Aspect 30 (see FIG. 7): The EM device (1000) of claim 29, wherein: each signal feed of the plurality of signal feeds (7000) is centrally disposed on a triangular face (faceted surface) (3174) of the associated 3D triangular pyramid shape opposite the opposing edge (3172).

Aspect 31: The EM device (1000) of any one of Aspects 26 to 30, wherein: each signal feed (7000, 7500) of the plurality of signal feeds comprises any one of: a slotted aperture (6502) in an electrical ground surface (6500) (see FIGS. 2C and 3B for example); or, a signal wire (6504) (see FIGS. 6A-6D for example).

Aspect 32 (see FIGS. 8A-8B for example): An EM device (1000), comprising: a plurality of the EM device (1000) of any one of the foregoing Aspects forming an x-by-y array (8000) of a plurality of the DRA subarray (3000).

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. An electromagnetic, EM, device (1000) configured to be operational at a defined center frequency, f, having a free space wavelength, λ, the EM device (1000) comprising:
a plurality of dielectric resonator antennas, DRAs, that can resonate at the same frequency, f, (3100) forming a unit cell (3200) having an overall footprint of equal to or less than λ/2 in both x and y directions of an orthogonal x-y-z coordinate system, as observed in a plan view of the EM device (1000), where the z-direction is a direction of vertical extension of each DRA (3100′) of the plurality of DRAs (3100), the unit cell (3200) defining a DRA subarray (3000).

2. The EM device (1000) of claim 1, wherein: the unit cell (3200) is a monolithic construct.

3. The EM device (1000) of claim 1, wherein: each DRA (3100′) of the plurality of DRAs (3100) is a solid, non-hollow, construct.

4. The EM device (1000) of claim 1, wherein: the unit cell (3200) is a dielectric-only construct.

5. The EM device (1000) of claim 1, wherein: the unit cell (3200) comprises a magneto-dielectric material.

6. The EM device (1000) of claim 1, wherein: each DRA (3100′) of the plurality of DRAs (3100) has a same 3D shape and size (3150).

7. The EM device (1000) of claim 6, wherein:
the 3D shape (3150) of each DRA (3100′) has a proximal end (3102) proximate a base (3202) of the unit cell (3200), the base (3202) being monolithic with each DRA (3100′), and an opposing distal end (3104) at a distance from the base (3202), the 3D shape (3150) tapering inward from the proximal end (3102) to the distal end (3104) to form and define non-DRA space (4000) between each adjacent DRA (3100′) of the plurality of DRAs (3100).

8. The EM device (1000) of claim 7, wherein:
the DRA subarray (3000) comprises a dielectric material having a first dielectric constant, Dk, value; and
the non-DRA space (4000) comprises a dielectric material having a second Dk value that is less than the first Dk value.

9. The EM device (1000) of claim 8, wherein:
the first Dk value is equal to or greater than 50 and equal to or less than 2,000, alternatively equal to or greater than 100 and equal to or less than 1,000; and
the second Dk value is equal to or greater than 1 and equal to or less than 5.

10. The EM device (1000) of claim 7, wherein:
The inwardly tapered 3D shape (3150) has a first effective dielectric constant, Dk, value at the proximal end (3102), and a second effective Dk value at the distal end (3104) that is less than the first effective Dk value;
wherein the respective effective Dk value is defined by the Dk value associated with incremental and uniform 3D cross sectional slices (3510) in the z-direction of a non-tapered envelope (3500) that bounds both the 3D shape (3150) of the respective DRA (3100′) and the associated portion of non-DRA space (4000) about the respective DRA (3100′);
wherein a thickness h of the 3D cross sectional slices (3510) in the z-direction is equal to or less than 10% of an overall height H of the respective DRA (3100′) in the z-direction.

11. The EM device (1000) of claim 10, wherein:
the first effective Dk value is equal to or greater than 8 and equal to or less than 16, alternatively equal to or greater than 16 and equal to or less than 100, further alternatively equal to or greater than 100 and equal to or less than 1000; and
the second effective Dk value is equal to or greater than 1 and equal to or less than 5, alternatively equal to or greater than 2.5 and equal to or less than 4.

12. The EM device (1000) of claim 7, wherein:
the inwardly tapered 3D shape (3150) has a taper angle α of equal to or greater than 5-degrees and equal to or less than 35-degrees; alternatively, equal to or greater than 25-degrees and equal to or less than 30-degrees; alternatively, equal to or greater than 5-degrees and equal to or less than 20-degrees.

13. The EM device (1000) of claim 12, wherein:
the 3D shape (3150) of each DRA (3100′) has overall outside footprint dimensions, a and b, at the proximal end (3102), and an overall height, H, from the proximal end (3102) to the distal end (3104); and
H is greater than a, or H is greater than b; alternatively, H is greater than a, and H is greater than b.

14. The EM device (1000) of claim 13, wherein:
the relationship between H, a, and α, is defined by: TAN(α)=a/(2H).

15. The EM device (1000) of claim 13, wherein:
H is equal to or greater than three times a, or H is equal to or greater than three times b;
alternatively, H is equal to or greater than three times a, and H is equal to or greater than three times b.

16. The EM device (1000) of claim 7, wherein:
the 3D shape (3150) of each DRA (3100′) has a faceted surface (3152) that faces another faceted surface (3154) of an adjacent one of the plurality of DRAs (3100).

17. The EM device (1000) of claim 7, wherein:
the DRA subarray (3000) is structurally configured to guide an E-field (5000), when present in the EM device (1000), in the non-DRA space (4000) between each DRA (3100′) of the plurality of DRAs (3100).

18. The EM device (1000) of claim 7, wherein:
a direction of EM radiation (5500), when present in the EM device (5000), is directed from the proximal end (3102) of each DRA (3100′) toward the distal end (3104) of each DRA (3100).

19. The EM device (1000) of claim 7, further comprising:
an encapsulant (1400) disposed encapsulating the DRA subarray (3000) and the non-DRA space (4000) between each adjacent DRA (3100′) of the plurality of DRAs (3100).

20. The EM device (1000) of claim 19, wherein:
the encapsulant (1400) comprises a dielectric material.

21. The EM device (1000) of claim 20, wherein:
the dielectric material of the encapsulant (1400) has a Dk value greater than 1 and equal to or less than 5, alternatively equal to or greater than 2 and equal to or less than 4.

22. The EM device (1000) of claim 1, wherein: f is equal to or greater than 50 KHz and equal to or less than 50 MHZ, alternatively f is equal to or greater than 1 GHz, and equal to or less than 1000 GHz.

23. The EM device (1000) of claim 1, wherein: the DRA subarray (3000) is at least a 2×2 array of the plurality of DRAs (3100); alternatively, the DRA subarray (3000) is at least a 13×13 array of the plurality of DRAs (3100).

24. The EM device (1000) of claim 1, wherein: each DRA (3100′) of the plurality of DRAs (3100) has a 3D rectangular pyramid shape (3160).

25. The EM device (1000) of claim 1, wherein: each DRA (3100′) of the plurality of DRAs (3100) has a 3D triangular pyramid shape (3170).

26. The EM device (1000) of claim 1, further comprising:
a plurality of signal feeds (7000) disposed in a one-to-one relationship with a respective one of the plurality of DRAs (3100).

27. The EM device (1000) of claim 1, further comprising:
a plurality of signal feeds (7500) disposed in a two-to-one relationship with a respective one of the plurality of DRAs (3100) forming a pair of the plurality of signal feeds (7500);
wherein each pair of the plurality of signal feeds (7500) for each respective DRA (3100′) of the plurality of DRAs (3100) are disposed to electromagnetically excite the respective DRA (3100′) in two different directions.

28. The EM device (1000) of claim 24, further comprising:
a plurality of signal feeds (7500) disposed in a two-to-one relationship with a respective one of the plurality of DRAs (3100) forming a pair of the plurality of signal feeds (7500);
wherein each pair of the plurality of signal feeds (7500) for each respective DRA (3100′) of the plurality of DRAs (3100) are disposed to electromagnetically excite the respective DRA (3100′) in two orthogonal directions.

29. The EM device (1000) of claim 25, further comprising:
a plurality of signal feeds (7000) disposed in a one-to-one relationship with a respective one of the plurality of DRAs (3100);
wherein each signal feed of the plurality of signal feeds (7000) in combination with an opposing edge (3172) of the 3D triangular pyramid shape for each respective DRA (3100′) of the plurality of DRAs (3100) are disposed to electromagnetically excite the respective DRA (3100′) to facilitate circular polarization EM radiation.

30. The EM device (1000) of claim 29, wherein:
each signal feed of the plurality of signal feeds (7000) is centrally disposed on a triangular face (3174) of the associated 3D triangular pyramid shape opposite the opposing edge (3172).

31. The EM device (1000) of claim 26, wherein:
each signal feed (7000, 7500) of the plurality of signal feeds comprises any one of: a slotted aperture (6502); or, a signal wire (6504).

32. (canceled)
